(19) United States
(12) Patent Application Publication
(10) Pub. No.: US 2026/0080740 A1
(43) Pub. Date: Mar. 19, 2026

(54) GAMING MACHINE, GAMING METHOD, AND STORAGE MEDIUM

(71) Applicant: Konami Gaming, Inc., Las Vegas, NV (US)

(72) Inventor: Ryu SASAKI, Zama-shi (JP)

(21) Appl. No.: 19/402,837

(22) Filed: Nov. 26, 2025

Related U.S. Application Data
(63) Continuation-in-part of application No. 19/268,864, filed on Jul. 14, 2025.

(30) Foreign Application Priority Data
Jul. 22, 2024 (JP) 2024-117019

(51) Int. Cl. G07F 17/32

(52) U.S. Cl. CPC G07F 17/3213; G07F 17/3267; G07F 17/3258

(57) ABSTRACT

A gaming machine for displaying a computer-animated reel game is described herein. The gaming machine includes a graphical user interface (GUI) and one or more processors programmed to execute an algorithm to display an animated sequence of computer-generated images including the steps rendering a bonus feature game grid including a 5×5 matrix on the GUI, animating a bonus feature symbol to appear in a center cell displaying a initial credit amount, and initially displaying a plurality of independent unisymbol reels the bonus feature game grid displaying a null symbol. The one or more processors then spin and stop the plurality of independent unisymbol reels to display a group of credit prize symbols arranged along a winning line extending through the bonus feature symbol, animate the group of credit prize symbols to collapse into the bonus feature symbol, and modify the bonus feature symbol to display an updated credit amount.

### CROSS-REFERENCE TO RELATED APPLICATIONS

This application is a continuation-in-part of U.S. patent application Ser. No. 19/268,864, filed Jul. 14, 2025, which claims the benefit of priority from Japanese Patent Application No. 2024-117019, filed on Jul. 22, 2024, the disclosures of which are hereby incorporated by reference in their entirety for all purposes.

### TECHNICAL FIELD

The present invention relates to a gaming machine, a control method for operating a gaming machine to display computer animated reel games.

### BACKGROUND

U.S. Pat. No. 6,840,858 discloses a gaming machine that provides a slot game and a bingo game. This gaming machine prepares a bingo card in which numbers are prearranged in a matrix, draws numbers based on the symbol stop result of the slot game, and provides a bingo game award when the drawn numbers are aligned in a line on the bingo card.

### SUMMARY

In the gaming machine described in U.S. Pat. No. 6,840,858, although the slot game and the bingo game are linked, there is no change in the rules of the slot game or the basic rules of the bingo game. Therefore, the slot game and the bingo game are essentially provided as independent games, lack novel features necessary to attract the interest of players, and fail to sufficiently provide new stimulation and excitement to satisfy players. The present disclosure provides a game that has novel features to attract the interest of players and sufficiently provides new stimulation and excitement to players by fusing elements of a bingo game and a slot game.

A gaming machine according to one aspect of the present disclosure includes: a display region configured to display symbols in each of cells arranged in a matrix, the display region being provided with a win line composed of a plurality of cells, the symbols including predetermined symbols associated with a predetermined amount of award; and a control unit connected to the display unit, wherein the control unit is configured to: execute an action to cause the symbols to randomly appear in blank cells of the display region; hold the predetermined symbols displayed in the cells after execution of the action, and execute the action again with the cells in which the predetermined symbols are not displayed as the blank cells; when all the cells of a single win line are filled with the predetermined symbols after executions of the action, generate a new predetermined symbol based on a total amount of awards associated with the predetermined symbols displayed on the single win line, hold the new predetermined symbol in one of the cells of the single win line, and set remaining cells of the single win line as the blank cells; and provide to the player a total amount of the award associated with the predetermined symbols displayed in the display region after repeating the action until an end condition is satisfied.

In this gaming machine, an action is executed in which symbols including the predetermined symbols randomly appear in the blank cells of the display region. After execution of the action, the displayed predetermined symbols are held in their respective cells, and the cells in which the predetermined symbols are not displayed become blank cells, and the above action is executed again. The predetermined symbols are associated with an amount of award, and the total amount of awards associated with the displayed predetermined symbols are provided to the player after the end of the game. Here, when all the cells constituting a single win line are filled with the predetermined symbols, the same state as a win (bingo) in a bingo game is achieved. In such a state, a new predetermined symbol is generated based on the total amount of awards associated with the predetermined symbols displayed on the single win line. The new predetermined symbol is held in one of the cells constituting the single win line, and the remaining cells constituting the single win line become blank cells. In this way, a plurality of the predetermined symbols that filled the single win line is represented by a single predetermined symbol, and the remaining cells are returned to blank cells. As a result, the above action is executed again for a larger number of blank cells. Here, in this gaming machine, the more blank cells there are, the higher the probability that the predetermined symbols will be displayed. Therefore, after securing the amount of award obtained by achieving the bingo state (a state in which a predetermined number of symbols are arranged in a line), it is possible to provide a game state in which the possibility of acquiring awards is increased by increasing the number of blank cells. In addition, by returning the remaining cells to blank cells as described above, it is possible to avoid the situation where all the cells in the display region are filled and the game ends, thus allowing for longer play. Furthermore, it is possible for a line that has once achieved the bingo state to achieve the bingo state again, or for a line that is just before the bingo state (a “one more to go” state) to have the predetermined symbols removed and the one more to go state canceled. In this way, this gaming machine introduces a new function of changing the game state upon achieving the bingo state, and introduces new rules that can result in re-bingo or cancellation of the one more to go state, thereby providing a game development full of changes. Therefore, this gaming machine can provide a novel game that fuses elements of a bingo game and a slot game, and sufficiently provides new stimulation and excitement to players by new rules.

In one embodiment, the control unit may cause the symbols to randomly appear in the cells by spinning reels including the symbols. In this case, the gaming machine can allow the player to visually recognize the process of the appearance of the symbols, enabling the player to play while predicting and expecting in which cell a new predetermined symbols will appear, thereby enhancing the sense of immersion in the game.

In one embodiment, the reels including the symbols may be provided for each of the cells and may be spun and stopped in the cells. In this case, since the reels spin on a cell-by-cell basis, the gaming machine can clarify the process of the appearance of the symbols and make it easier for the player to understand the game.

In one embodiment, the predetermined symbols may include credit symbol displaying a credit amount, and the control unit may, when all the cells of the single win line are filled with the predetermined symbols after executions of the action, total the credit amounts displayed on the credit symbol located in the cells of the single win line as the amount of award. When a win is achieved, the predetermined symbols other than the generated predetermined symbols are released and become blank cells. Since the credit amounts of the credit symbols are totaled as the amount of award and become the credit amount of the new credit symbol, even if the holding of the credit symbols displayed in the blank cells is released, the credit amount is carried over. Therefore, it is possible to avoid a situation in which the amount of award is reduced due to the release of the holding of the credit symbol.

In one embodiment, the predetermined symbols may include multiplier symbol associated with a multiplier, and the control unit may, when the multiplier symbol appears in a cell of the single win line, hold the multiplier symbol in the cell with a locked state where the effect of the multiplier is not exerted, and when all the cells of the single win line are filled with the predetermined symbols, release the locked state of the multiplier symbol held in the cells on the single win line, increase the credit amounts of all the credit symbols held in the cells of the single win line by the multiplier corresponding to the multiplier symbol whose locked state has been released, and total the increased credit amounts as the amount of award. In this case, the gaming machine can provide new stimulation and excitement by a new rule in which the effect of the multiplier is not exerted just by being displayed, but is exerted by achieving the bingo state.

In one embodiment, the predetermined symbols may include jackpot symbol associated with a rank, and the control unit may, when the jackpot symbol appears in a cell of the single win line, hold the jackpot symbol in the cell with a locked state where the effect of the jackpot is not exerted, and when all the cells of the single win line are filled with the predetermined symbols, release the locked state of the jackpot symbol, convert the rank of the jackpot symbol whose locked state has been released into a credit amount, and total the converted credit amount and the credit amounts of all the credit symbols held in the cells of the single win line as the amount of award. In this case, the gaming machine can provide new stimulation and excitement by a new rule in which the effect of the jackpot is not exerted just by being displayed, but is exerted by achieving the bingo state.

In one embodiment, the control unit may decrease a remaining number of the action, which is set to an initial value, each time the action is executed, and when a new predetermined symbol appears by execution of the action, return the remaining number to the initial value, and set the end condition as the remaining number becoming zero. Since the game ends not when the bingo state is achieved, but when the remaining number of actions becomes zero, the player can expect to achieve the bingo state multiple times in a single game. Furthermore, since the remaining number is reset each time the predetermined symbols appear, the predetermined symbols can be given a function of resetting the remaining number in addition to its function as an element for achieving the bingo state. In addition, since the possibility that a new predetermined symbol will stop and the game will continue increases by releasing the holding of the predetermined symbols, the expectation that the game will continue by achieving the bingo state can be enhanced.

A game providing method according to another aspect of the present disclosure is a game providing method executed in a gaming machine including a display unit having a display region configured to display symbols in each of cells arranged in a matrix, the display region being provided with a win line composed of cells, the symbols including predetermined symbols associated with a predetermined amount of award, and a control unit connected to the display unit, the control unit performing the steps of: executing an action to cause the symbols to randomly appear in blank cells of the display region; holding the predetermined symbols displayed in the cells after execution of the action, and executing the action again with the cells in which the predetermined symbols are not displayed as the blank cells; when all the cells of a single win line are filled with the predetermined symbols after executions of the action, generating a new predetermined symbol based on a total amount of awards associated with the predetermined symbols displayed on the single win line, holding the new predetermined symbol in one of the cells of the single win line, and setting the remaining cells of the single win line as the blank cells; and providing to the player a total amount of the award associated with the predetermined symbols displayed in the display region after repeating the action until an end condition is satisfied. This game providing method achieves the same effects as the above gaming machine.

A non-transitory computer-readable storage medium storing a program according to another aspect of the present disclosure is a program executed by a control unit in a gaming machine including a display unit having a display region configured to display symbols in each of cells arranged in a matrix, the display region being provided with a win line composed of a plurality of the cells, the symbols including predetermined symbols associated with a predetermined amount of award, and a control unit connected to the display unit, the program causing the control unit to: execute an action to cause the symbols to randomly appear in blank cells of the display region; hold the predetermined symbols displayed in the cells after execution of the action, and execute the action again with the cells in which the predetermined symbols are not displayed as the blank cells; when all the cells of a single win line are filled with the predetermined symbols after executions of the action, generate a new predetermined symbol based on a total amount of awards associated with the predetermined symbols displayed on the single win line, hold the new predetermined symbol in one of the cells of the single win line, and set remaining cells of the single win line as the blank cells; and provide to the player a total amount of the award associated with the predetermined symbols displayed in the display region after repeating the action until an end condition is satisfied. This program achieves the same effects as the above gaming machine.

According to the present disclosure, there are provided a gaming machine, a game providing method, and a program capable of providing a game that has novel features to attract the interest of players and sufficiently provides new stimulation and excitement to players by fusing elements of a bingo game and a slot game.

In one aspect of the present invention, a gaming machine for displaying a computer-animated reel game is provided. The gaming machine includes a cabinet, a display device mounted to the cabinet and including graphical user interface (GUI) displaying computer-generated images thereon, and a control unit operably coupled to the display device and including one or more processors programmed to execute an algorithm to display an animated sequence of computer-generated images on the display device GUI. The one or more processors execute the algorithm including the steps of rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column. The one or more processors animate the plurality of primary game reels to spin through the primary game grid and sequentially stop to display a plurality of game symbols and a plurality of feature trigger symbols within the primary game grid, and animate a bingo-type bonus feature to appear on the GUI by animating each displayed feature trigger symbol to display a corresponding credit amount, animating the primary game grid to transform into a bonus feature game grid including a second plurality of cells arranged in a 5×5 matrix, animating a bonus feature symbol to appear in a center cell of the 5×5 matrix displaying a initial credit amount equal to a sum of the credit amounts displayed with the feature trigger symbols, generating a plurality of independent unisymbol reels including a plurality of null symbols and at least one credit prize symbol displaying a credit value, and initially displaying the plurality of independent unisymbol reels within each other cell of the bonus feature game grid displaying a null symbol. The one or more processors execute an instance of the bingo-type bonus feature by spinning and stopping the plurality of independent unisymbol reels to display a group of credit prize symbols arranged along a winning line extending through the bonus feature symbol, animating the group of credit prize symbols to collapse into the bonus feature symbol, and modifying the bonus feature symbol to display an updated credit amount equal to a sum of the credit values displayed with the group of credit prize symbols arranged along the winning line and the initial credit amount.

In another aspect of the present invention, a method of operating a gaming machine for displaying a computer-animated reel game is provided. The gaming machine includes a cabinet, a display device mounted to the cabinet and including graphical user interface (GUI) displaying computer-generated images thereon, and a control unit operably coupled to the display device and including one or more processors programmed to execute an algorithm to display an animated sequence of computer-generated images on the display device GUI. The method includes the one or more processors performing the algorithm including the steps of rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column. The one or more processors animate the plurality of primary game reels to spin through the primary game grid and sequentially stop to display a plurality of game symbols and a plurality of feature trigger symbols within the primary game grid, and animate a bingo-type bonus feature to appear on the GUI by animating each displayed feature trigger symbol to display a corresponding credit amount, animating the primary game grid to transform into a bonus feature game grid including a second plurality of cells arranged in a 5×5 matrix, animating a bonus feature symbol to appear in a center cell of the 5×5 matrix displaying a initial credit amount equal to a sum of the credit amounts displayed with the feature trigger symbols, generating a plurality of independent unisymbol reels including a plurality of null symbols and at least one credit prize symbol displaying a credit value, and initially displaying the plurality of independent unisymbol reels within each other cell of the bonus feature game grid displaying a null symbol. The one or more processors execute an instance of the bingo-type bonus feature by spinning and stopping the plurality of independent unisymbol reels to display a group of credit prize symbols arranged along a winning line extending through the bonus feature symbol, animating the group of credit prize symbols to collapse into the bonus feature symbol, and modifying the bonus feature symbol to display an updated credit amount equal to a sum of the credit values displayed with the group of credit prize symbols arranged along the winning line and the initial credit amount.

In yet another aspect of the present invention, a non-transitory computer-readable storage media having computer-executable instructions embodied thereon to operate a gaming machine for displaying a computer-animated reel game is provided. The gaming machine includes a cabinet, a display device mounted to the cabinet and including graphical user interface (GUI) displaying computer-generated images thereon, and a control unit operably coupled to the display device and including one or more processors programmed to execute an algorithm to display an animated sequence of computer-generated images on the display device GUI. When executed by the one or more processors, the computer-executable instructions cause the one or more processors to perform the algorithm including the steps of rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column. The one or more processors animate the plurality of primary game reels to spin through the primary game grid and sequentially stop to display a plurality of game symbols and a plurality of feature trigger symbols within the primary game grid, and animate a bingo-type bonus feature to appear on the GUI by animating each displayed feature trigger symbol to display a corresponding credit amount, animating the primary game grid to transform into a bonus feature game grid including a second plurality of cells arranged in a 5×5 matrix, animating a bonus feature symbol to appear in a center cell of the 5×5 matrix displaying a initial credit amount equal to a sum of the credit amounts displayed with the feature trigger symbols, generating a plurality of independent unisymbol reels including a plurality of null symbols and at least one credit prize symbol displaying a credit value, and initially displaying the plurality of independent unisymbol reels within each other cell of the bonus feature game grid displaying a null symbol. The one or more processors execute an instance of the bingo-type bonus feature by spinning and stopping the plurality of independent unisymbol reels to display a group of credit prize symbols arranged along a winning line extending through the bonus feature symbol, animating the group of credit prize symbols to collapse into the bonus feature symbol, and modifying the bonus feature symbol to display an updated credit amount equal to a sum of the credit values displayed with the group of credit prize symbols arranged along the winning line and the initial credit amount.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display area of the gaming machine of FIG. 1.

FIG. 4A is a diagram illustrating an example of a virtual reel set data file used in a normal game.

FIG. 4B is a diagram illustrating an example of a bonus virtual reel strip data file used in a feature game.

FIG. 5A is a diagram illustrating an example of a symbol image data file used in a normal game.

FIG. 5B is a diagram illustrating an example of bonus symbol image data file used in a feature game.

FIGS. 6A and 6B are diagrams illustrating a state of symbol arrangement in a normal game.

FIGS. 7A and 7B are diagrams illustrating an example of a display screen in the start processing of a feature game.

FIGS. 8A and 8B are diagrams illustrating a state of symbol arrangement in a feature game.

FIGS. 9A and 9B are diagrams illustrating a state of symbol arrangement in a feature game.

FIGS. 10A and 10B are diagrams illustrating a state of symbol arrangement in a feature game.

FIGS. 11A and 11B are diagrams illustrating a state of symbol arrangement in a feature game.

FIGS. 12A to 12D are diagrams illustrating a state of symbol arrangement in a feature game.

FIGS. 13A to 13D are diagrams illustrating a state of symbol arrangement in a feature game.

FIGS. 14A to 14D are diagrams illustrating a state of symbol arrangement in a feature game.

FIGS. 15A to 15D are diagrams illustrating a state of symbol arrangement in a feature game.

FIG. 16 is a directory configuration diagram and a block diagram showing programs and data stored in the memory shown in FIG. 2.

FIG. 17 is a block diagram of a system for a gaming machine.

FIG. 18 is a block diagram of the game application program of FIG. 17.

FIG. 19 is a block diagram of the system application program shown in FIG. 17.

FIGS. 20-21 are flowcharts illustrating algorithms used during operation of the gaming machine.

FIGS. 22-33 are exemplary illustrations of animated sequences of computer-generated icons rendered on game screens illustrating the algorithms shown in FIGS. 20-21.

Corresponding reference characters indicate corresponding parts throughout the drawings.

### DETAILED DESCRIPTION

Hereinafter, a gaming machine according to an embodiment will be described with reference to the accompanying drawings. In the drawings, the same or corresponding portions are denoted by the same reference numerals, and redundant description is omitted. As used herein, the plural form of a noun (e.g., “predetermined symbols”) is intended to encompass the singular form (e.g., “a predetermined symbol”) as well, and vice versa, unless the context clearly dictates otherwise. Therefore, reference to “predetermined symbols” includes instances where only a single type of predetermined symbol is present or involved, as well as instances where multiple types of predetermined symbols are present or involved.

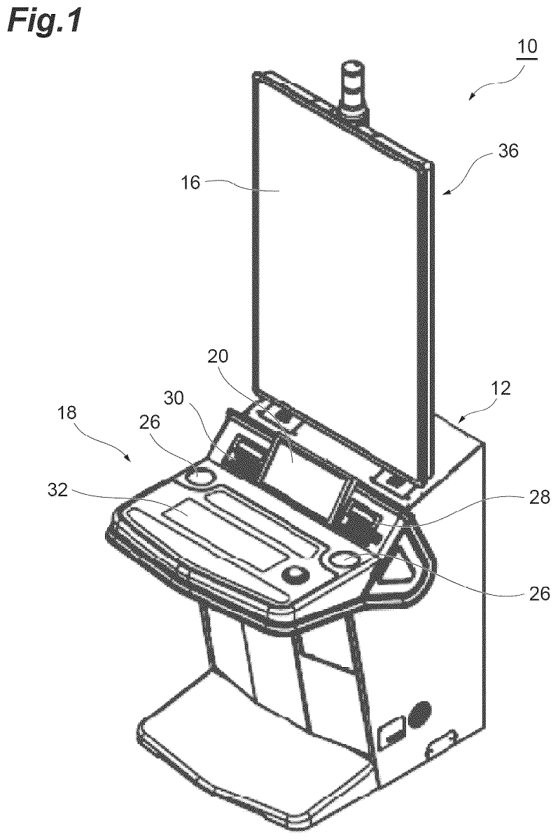

FIG. 1 is a perspective view illustrating an example of a gaming machine according to an embodiment. Here, the gaming machine is a device that receives a wager such as cash, medals, or tokens from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. The gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game, a free game, and a bonus feature game. The normal game, free game, and bonus feature game are provided when a predetermined condition is satisfied. In the normal game, free game, and bonus feature game, symbols displayed in the display region constitute a game result (such as a combination of symbols), and a winning is determined.

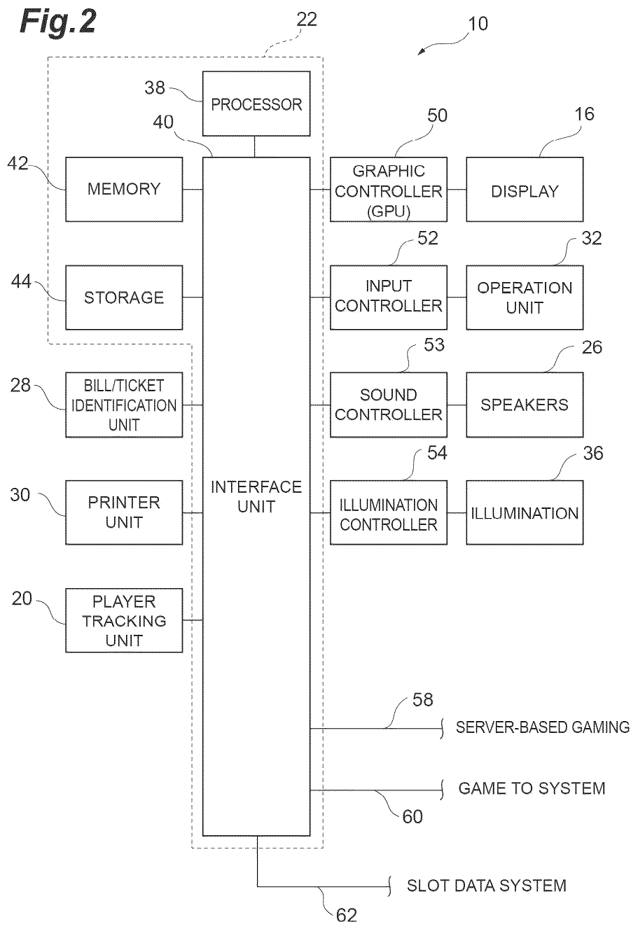

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device including a graphical user interface (GUI) displaying computer-generated images thereon. The display 16 is controlled via the control unit 22 to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchanged for cash by a kiosk terminal inside of the casino or casino cage.

The operation unit 32 receives an operation of the player. The operation unit 32 includes a group of buttons for receiving various instructions from the player on the gaming machine 10. For example, the operation unit 32 may include a group of a spin button and setting buttons. The spin button receives an instruction to start an instance of a game (start rotation of reel). The group of setting buttons includes a group of bet buttons and the like, such as a cash-out button. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 that includes one or more processors constituting the control unit 22, an interface unit 40, a memory device 42 (an example of a storage unit), a storage 44 (an example of a storage unit), and the like. The control unit 22 may be housed inside the cabinet 12 as a control board. The control unit 22 is configured to be able to communicate with each unit via the interface unit 40, and controls the operation of each unit by executing a program recorded in the memory device 42 or the storage 44 of CPU 38 to provide a game to the player.

The interface unit 40 includes a chipset that provides communication functions for CPU 38, such as a memory bus connected to the CPU 38, various expansion buses, a serial interface, a universal serial bus (USB) interface, an Ethernet interface (registered trademark), and the like.

The memory device 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reader such as a memory card and a magneto-optical disk which are removable storage media, and can also use a hard disk.

The bill/ticket identification unit 28, the printer unit 30, a player tracking unit 20, a graphics controller (GPU: Graphics Processing Unit) 50, an input controller 52, a sound controller 53, and an illumination controller 54 are connected to the interface unit 40. The graphics controller 50, the input controller 52, the sound controller 53, and the illumination controller 54 may be housed inside cabinet 12 as control boards.

The control unit 22 is connected to the display 16 via the graphics controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the type of bills or payout processing of credit. The control unit 22 increases the credit amount usable in the game according to the notified contents. The printer unit 30 prints information corresponding to payout processing of credit from the gaming machine 10 on a ticket and outputs it under the control of the control unit 22 which receives the operation of a cash-out button included in the operation unit 32.

The player tracking unit 20 cooperates with the control unit 22 to transmit and receive player information and the like to and from the casino management system. The graphics controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the outside of the gaming machine 10. The interface unit 40 may communicate with external networks by Ethernet 58, 60 and a serial interface 62, as examples. FIG. 2 shows an example of communication with other gaming machines 10, a known server-side gaming network (Server-Based gaming), a G2S network (Game to System), and a slot information system (Slot Data System).

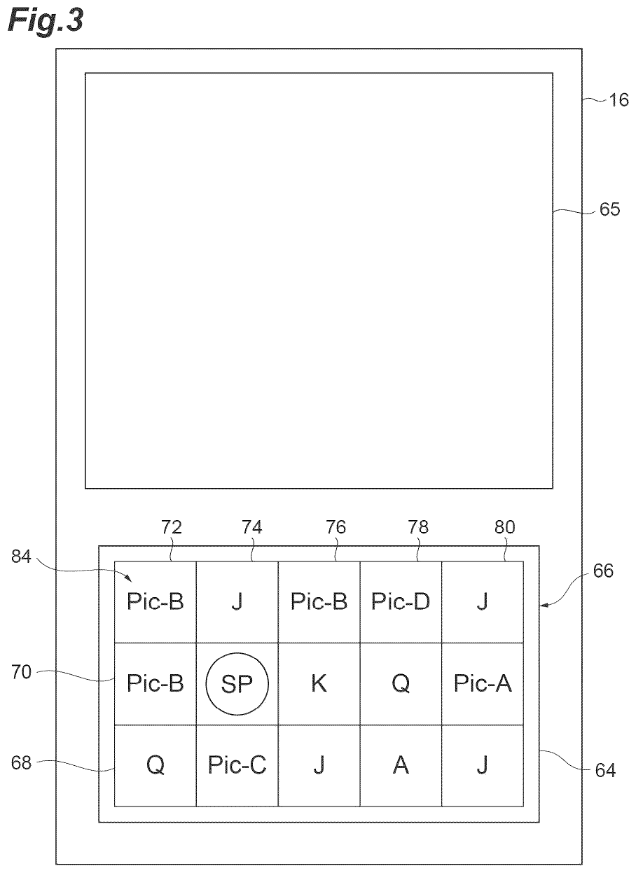

FIG. 3 is a schematic diagram of a display area of the gaming machine of FIG. 1. As shown in FIG. 3, a game screen is displayed in the display region of the display 16 by the control unit 22 executing a predetermined program. The game screen includes a symbol display region 64 for displaying a slot game. The symbol display region 64 is displayed in the lower region of the game screen as an example. Above the symbol display region 64, a region 65 is provided for displaying information related to the game and the like.

The symbol display region 64 includes a grid 68 capable of displaying symbols. By using such a display region, the gaming machine 10 operates as a slot machine that performs a winning determination according to a combination of symbols displayed on the grid 68 in the symbol display region 64 and provides a payout.

The display 16 displays a plurality of symbols in the grid 68. The grid 68 includes a plurality of rows and columns. The grid 68 is constituted by a plurality of cells 70 which are stop positions of symbols. FIG. 3 illustrates a game screen including a plurality of cells arranged in a 5×3 grid pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game progress and/or the bet amount. One symbol is stopped and displayed on each of a plurality of the cells 70 in the symbol display region 64.

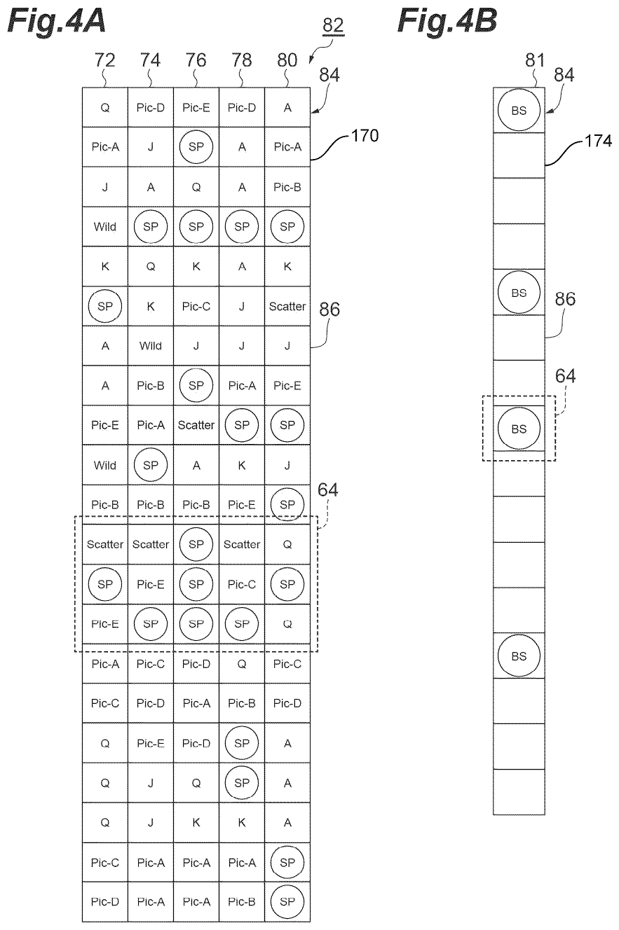

A symbol arranged in each of the plurality of cells 70 is determined by using a virtual reel strip for displaying a virtual reel 66. FIG. 4A is a diagram illustrating an example of a virtual reel set data file 170 stored in the memory device 42 and including computer-executable instructions for rendering the virtual reels 66 on the display device GUI 16 during in a normal game. For example, the virtual reel set data file 170 includes computer-executable instructions for rendering a plurality of virtual reel strips, and the virtual reel strip includes symbol arrangements indicating the order of symbols displayed in the display region. On each cell 70 of the grid 68 shown in FIG. 3, symbols are displayed based on symbol arrangements of the virtual reel 66 including virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strip 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data, and the control unit 22 uses a program included in the memory 42 or the storage 44, and data showing the symbol arrangement (i.e., the order of symbols on each reel strip) regulated by each cell column. The virtual reel set 82 is a general term for such virtual reel strips 72 to 80.

The virtual reel strips 72 to 80 illustrated in FIG. 4A are constituted by symbol 84 in each symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

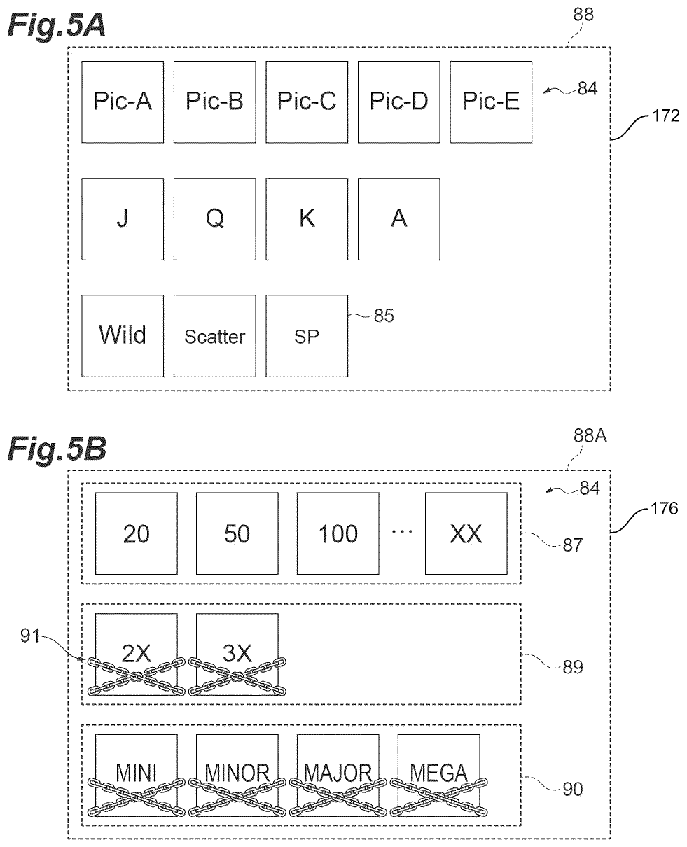

FIG. 5A is a diagram illustrating an example of a symbol image data file 172 stored in the memory device 42 and including computer-executable instructions for rendering images of a symbol set 88 including detail of the symbol 84 shown in FIG. 4A. Each of the virtual reel strips 72 to 80 includes symbols selected from the symbol set 88 of various symbol 84 shown in FIG. 5A. The symbol set 88 includes card symbol (“J”, “Q”, “K”, and “A”) imitating playing cards as regular symbol, and picture symbol (“Pic-A”, “Pic-B”, “Pic-C”, “Pic-D”, and “Pic-E”) indicating a person, animal/plant, object, treasure, or wealth.

The symbol set 88 includes a special symbol 85 (“SP”). The special symbol 85 is a symbol that triggers a bonus feature game described later. The special symbol 85 may be prepared separately from the regular symbol, or may be a symbol selected from the regular symbol. The symbol set 88 may further include a wild symbol (“Wild”) that is substituted as another symbol when a winning combination is determined, and a scatter symbol (“Scatter”) that triggers a free game in response to the appearance of a predetermined number of symbols when a winning combination is determined.

A plurality of virtual reel sets may be prepared according to the game content. For example, the virtual reel set used in the normal game and the virtual reel set used in the free game may be the same or different. The virtual reel set in the free game may include more picture symbol, wild symbol, or special symbol 85 than the virtual reel set in the normal game. In this way, it is possible to increase the winning probability or expected value during the free game, and it is possible to provide the player with a valuable free game.

FIG. 4B is a diagram illustrating an example of a bonus virtual reel strip data file 174 stored in the memory device 42 and including computer-executable instructions for rendering independent reels and/or unisymbol reels on the display device GUI 16 during in a bonus feature game. The bonus virtual reel strip data file 174 defines a virtual reel strip 81 including a symbol arrangement indicating the order of symbols displayed in the display region. The virtual reel strip 81 is provided for each cell 70 of the grid 68 as shown in FIG. 3. That is, in the case of a 3×3 grid, nine virtual reel strips 81 are provided, and in the case of a 5×5 grid, twenty-five virtual reel strips 81 are provided. In this way, reels provided for each cell, not for each column, are also called independent reels and/or unisymbol reels. In the symbol display region 64, symbols arranged in predetermined parts of the virtual reel strip 81 are displayed. Furthermore, by moving (scrolling or spinning) each symbol by cell based on the symbol arrangement of the virtual reel strip 81, the symbols displayed in the cells 70 of the grid 68 change, and by stopping the movement (scrolling or spinning) by cell, the symbols are stopped. The virtual reel strip 81 is data, and the control unit 22 uses a program included in the memory 42 or the storage 44, and data showing the symbol arrangement (i.e., the order of symbols on each reel strip) adjusted by each cell.

The virtual reel strip 81 shown in FIG. 4B is composed of symbol 84 at each symbol position 86, and these symbols are arranged in an order defined for each cell. The symbol 84 is a bonus symbol (an example of the predetermined symbol). That is, in the virtual reel strip 81, bonus symbols are arranged at selected symbol positions 86, and symbol positions 86 where no bonus symbol is arranged are left blank and/or include a null symbol appearing as a blank cell. Note that the number and arrangement of bonus symbols constituting the virtual reel strip 81 are not limited to these, and may be set to any desired number and arrangement. Also, the number of bonus symbols constituting the virtual reel strip 81 may be the same for each cell, or may be different for each cell.

FIG. 5B is a diagram illustrating an example of a bonus symbol image data file 176 stored in the memory device 42 and including computer-executable instructions for rendering images of a bonus symbol set 88 including detail of the symbol 84 shown in FIG. 4B. The virtual reel strip 81 includes bonus symbols selected from the bonus symbol set 88A of various symbol 84 shown in FIG. 5B.

The bonus symbol set 88A may include a credit symbol 87, which is associated with a predetermined credit amount as an award. The credit symbol 87 can maintain or enhance the player's interest by allowing the player to directly understand the credits that can be acquired and to directly understand the opportunity by the appearance of a credit symbol with a high credit amount. The credit symbol 87 can be, for example, a predetermined picture symbol such as a coin on which the credit amount to be awarded is displayed. In the example of FIG. 5B, a credit symbol with a credit amount of “20”, a credit symbol with a credit amount of “50”, a credit symbol with a credit amount of “100”, and a credit symbol with a credit amount of “XX” are shown. The credit amount “XX” means that any credit amount can be applied. Furthermore, the credit amount may not be displayed on the credit symbol while the symbol is changing, and the credit amount may be displayed after the symbol is stopped, or the credit amount may be displayed when a win occurs after the symbol is stopped.

The bonus symbol set 88A may include a multiplier symbol 89, which is associated with a multiplier. When the multiplier symbol 89 constitutes a win in the bonus feature game, the multiplier rate is applied to the credit amount of the credit symbol 87 that also constitutes the win. The multiplier symbol 89 can be, for example, a predetermined picture symbol such as a coin on which the multiplier to be awarded is displayed. In the example of FIG. 5B, “2X” indicating a multiplier of 2 times and “3X” indicating a multiplier of 3 times are shown. For example, when a multiplier symbol 89 with “2X” is awarded and constitutes a win together with a credit symbol 87 with a credit amount of “100”, the credit amount “100” is doubled to “200” as the award for the credit symbol 87.

The bonus symbol set 88A may include a jackpot symbol 90, which is associated with a jackpot tire (rank) instead of a credit amount. The jackpot tire is a level corresponding to the amount of the winning award, such as MINI, MAJOR, MAXI, or MEGA. For example, MINI is converted to a credit amount of “100”, MAJOR to “500”, MAXI to “1000”, and MEGA to “5000”. The jackpot symbol 90 can be, for example, a predetermined picture symbol such as a coin on which the jackpot tire to be awarded is displayed. When the jackpot symbol 90 constitutes a win together with a multiplier symbol 89, the multiplier rate of the multiplier symbol 89 may be applied to the credit amount corresponding to the jackpot tire of the jackpot symbol 90. Alternatively, the jackpot symbol 90 may be excluded from the application of the multiplier rate of the multiplier symbol 89.

The control unit 22 can restrict the effect of the multiplier symbol 89 and the jackpot symbol 90 from being exerted. The state in which the effect of the multiplier symbol 89 and the jackpot symbol 90 is not exerted is referred to as a “locked state”. The locked state of the multiplier symbol 89 and the jackpot symbol 90 is represented, for example, by adding a chain 91 that binds the symbols. The multiplier symbol 89 and the jackpot symbol 90 in the locked state are treated as mere symbols. When the multiplier symbol 89 or the jackpot symbol 90 in the locked state constitutes a win, the control unit 22 releases the locked state. As a result, the multiplier symbol 89 and the jackpot symbol 90 exert their effects. When the locked state is released, an effect is performed in which the chain 91 is removed from the symbol. The player can determine the presence or absence of the locked state by the presence or absence of the chain 91.

The gaming machine 10 of the present embodiment provides three types of games: a normal game (also referred to as a main game, primary game, and/or base game) provided when a predetermined condition is not satisfied, a first special game provided when a predetermined condition is satisfied, and a second special game provided when a predetermined condition is satisfied. The first special game is a free game, which is provided without consuming game value. The free game is provided a predetermined number of times when a predetermined trigger condition is satisfied. The second special game is a bonus feature game, in which a bonus feature not present in the normal game is applied. The bonus feature game is provided when a predetermined trigger condition is satisfied. The trigger condition for the bonus feature game can be set arbitrarily. For example, the trigger condition for the bonus feature game may be satisfied when a predetermined number or more of special symbol 85 are included in the symbol combination as a game result of the normal game or the free game. Alternatively, the trigger condition for the bonus feature game may be satisfied based on another random number, regardless of the game result.

In the above-described normal game and free game, a combination of symbols displayed in the symbol display region 64 among the symbol arrangement as a game result is subject to win determination. The control unit 22 starts the game and randomly determines the stopping position of each of the virtual reel strips 72 to 80. The virtual reel strips 72 to 80 displayed on the display 16 move (scroll or spin) from the current position and stop based on the stopping position to represent the game result. Therefore, in the display 16 or the grid 68, the symbols included in the virtual reel strips 72 to 80 change in accordance with continuous movement (scrolling or spinning) of the virtual reel strips 72 to 80 in the vertical direction of the symbol display region 64, and are displayed such that one symbol is stopped in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the combination of symbols stopped in the symbol display region 64.

Then, when a predetermined trigger condition is satisfied, the control unit 22 starts the bonus feature game. The bonus feature game according to the present embodiment is a novel game that fuses a slot game and a bingo game. In the symbol display region 64, cells arranged in a matrix are displayed like a bingo card. In a general bingo game, numbers predetermined for each cell are arranged, but in this bonus feature game, no numbers are arranged and the cells are blank. The control unit 22 executes an action to randomly cause bonus symbol to appear in each blank cell. The action may be an action in which symbols are drawn like a bingo game and the drawn symbols appear in the cells, an action in which symbols aligned in a slot game on another screen appear in the cells, or a reel action like a slot game in which independent reels are spun in the blank cells.

When a reel action is adopted, the control unit 22 randomly determines the stopping position of the virtual reel strip 81 for each cell. The virtual reel strip 81 displayed on the display 16 moves (scrolls or spins) from the current position and stops based on the stopping position to cause the bonus symbol to appear.

The control unit 22 fixes (holds) the bonus symbol that has appeared in the cell. As a result, a part of the blank cells are filled with bonus symbols. The control unit 22 executes the action again to randomly cause bonus symbol to appear, treating the cells in which bonus symbols have not been displayed as blank cells. The control unit 22 repeats the action until an end condition is satisfied. As an example, each time the action is executed, the control unit 22 decreases a remaining number of games (remaining number of actions) by one, and determines that the end condition is satisfied when the preset remaining number of games becomes zero. The preset remaining number of games is set to an initial value when the bonus feature game starts.

After repeating the action until the end condition is satisfied, the control unit 22 determines the total amount of awards (the total of the credit amounts of the credit symbol 87 and the credit amounts converted from the jackpot rank of the jackpot symbol 90) associated with the bonus symbol displayed in the symbol display region 64. The control unit 22 provides the determined total amount to the player as the award of the bonus feature game. Therefore, in the bonus feature game, causing a large number of bonus symbol to appear leads to a high payout.

The control unit 22 may reset the remaining number of games to the initial value when a new bonus symbol appears as a result of the action. Alternatively, the control unit 22 may increase the remaining number of games by a predetermined value when a new bonus symbol appears as a result of the action. As a result, the number of executable actions increases, making it possible to cause a large number of bonus symbol to appear and making it easier to achieve a high payout.

Furthermore, the control unit 22 sets win lines in the symbol display region 64, as in the case of determining a win (bingo) in a bingo game. In the case of a 5×5 grid, five vertical win lines each consisting of five vertically aligned cells, five horizontal win lines each consisting of five horizontally aligned cells, and two diagonal win lines each consisting of five diagonally aligned cells are set, for a total of twelve win lines. When, after execution of the action, all the cells constituting a single win line are filled with bonus symbol, the control unit 22 provides an advantageous situation for the player by increasing the number of blank cells while maintaining the acquired award amount. As used herein, “a single win line”refers to one of these win lines.

First, the control unit 22 calculates the total amount of awards associated with the bonus symbol displayed on the single win line. For example, the control unit 22 totals the credit amounts displayed on the credit symbol located in the cells constituting the single win line, and sets the total as the total amount of awards. Then, the control unit 22 generates a new bonus symbol based on the total amount of awards. For example, the control unit 22 generates a credit symbol 87 (a specific credit symbol) whose credit amount is the calculated total amount. The control unit 22 may generate the specific credit symbol by changing the credit amount of the held credit symbol 87.

In this way, the total amount acquired by the bonus symbol that filled the cells constituting the single win line is consolidated into a single specific credit symbol. The control unit 22 holds the specific credit symbol in one of the cells constituting the single win line. Then, the control unit 22 sets the remaining cells constituting the single win line as blank cells. In this way, when a bingo win is achieved, the cells that were once filled are reset to blank cells, making it possible to cause bonus symbol to appear again and making it easier to achieve a high payout.

The credit value of the specific credit symbol may be increased by the multiplier symbol 89. When the multiplier symbol 89 appears, the control unit 22 holds the multiplier symbol 89 in the cell in a locked state in which the effect of the multiplier is not exerted. Then, when all the cells constituting the single win line including the multiplier symbol 89 are filled with bonus symbols, the control unit 22 releases the locked state of the multiplier symbol 89 held in the cells constituting that win line. The control unit 22 increases the credit amounts of all the credit symbols held in the cells constituting that win line by the multiplier rate corresponding to the multiplier symbol 89 whose locked state has been released. The control unit 22 totals the increased credit amounts as the total amount of awards. Then, the control unit 22 generates the specific credit symbol based on the total amount of awards. In this way, when the multiplier symbol 89 is included in the bonus symbols at the time of a bingo win, the effect of the multiplier is exerted and the award is increased.

The credit value of the specific credit symbol may be increased by the jackpot symbol 90. When the jackpot symbol 90 appears, the control unit 22 holds the jackpot symbol 90 in the cell in a locked state in which the effect of the jackpot is not exerted. Then, when all the cells constituting the single win line including the multiplier symbol 89 are filled with bonus symbols, the control unit 22 releases the locked state of the jackpot symbol 90 held in the cells constituting that win line. The control unit 22 converts the jackpot rank of the jackpot symbol 90 whose locked state has been released into a corresponding credit amount. The control unit 22 calculates the total credit amount including the converted credit amount. Then, the control unit 22 generates the specific credit symbol based on the total amount of awards. In this way, when the jackpot symbol 90 is included in the bonus symbols at the time of a bingo win, the effect of the jackpot is exerted and the award is increased.

The control unit 22 may determine that the end condition is satisfied when a bonus symbol has appeared at least once in all the cells. When the bonus feature game ends in this way, a separate award may be provided.

The following describes an example in which a bonus feature game is triggered in a normal game or a free game and the bonus feature game is provided. As an example, the trigger condition for the bonus feature game is satisfied when six or more special symbol 85 are displayed.

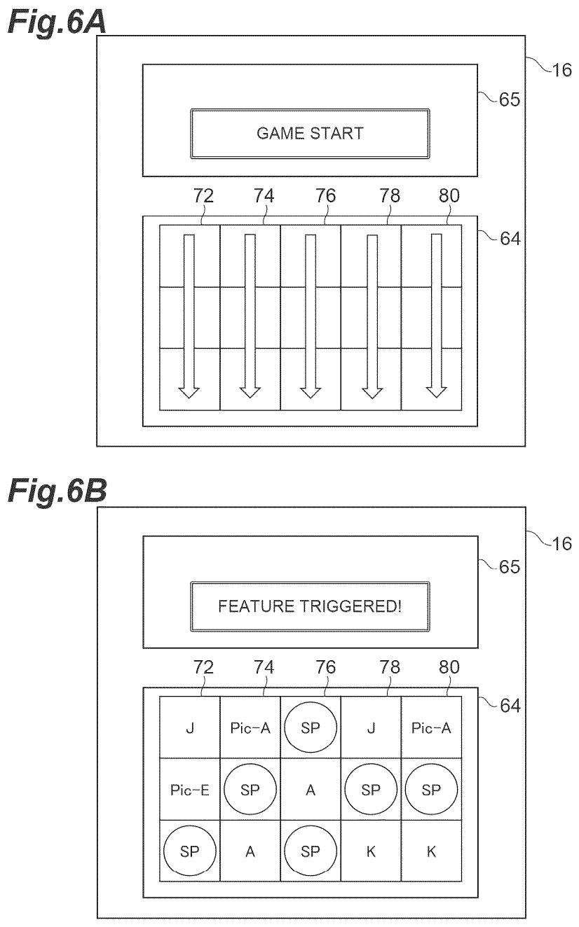

As shown in FIG. 6A, the control unit 22 spins the reels corresponding to the virtual reel strips 72 to 80 and stops them sequentially. As a result, the symbol combination shown in FIG. 6B is displayed as the game result. Since six special symbols 85 indicated by “SP” are included in the displayed symbol combination, the bonus feature game is triggered.

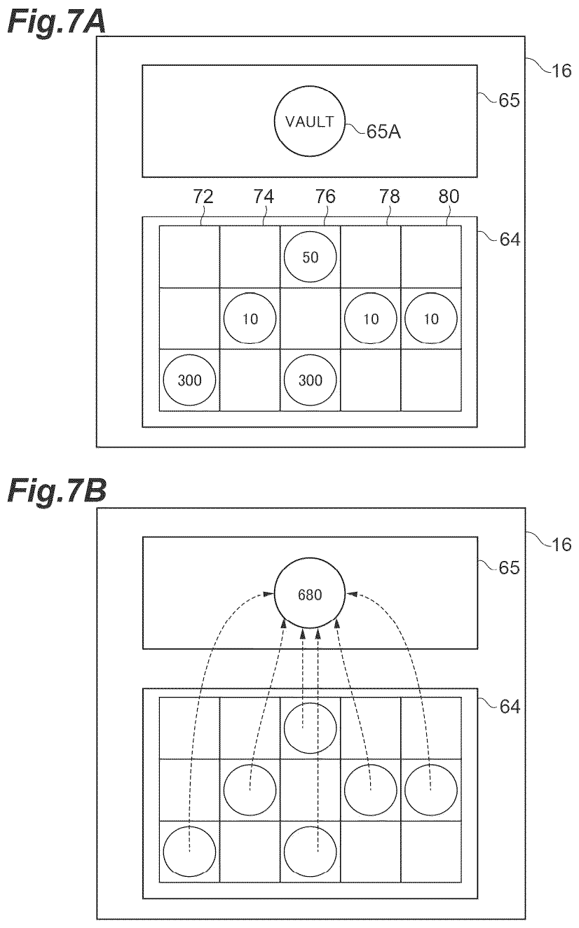

When the control unit 22 starts the bonus feature game, as shown in FIG. 7A, the special symbol 85 indicated by “SP” is converted into bonus symbol. Here, the special symbol 85 is converted into credit symbol 87. The credit amount of the credit symbol 87 may be determined randomly or may be a predetermined amount. In FIG. 7A, six of the special symbols 85 are each converted into credit symbols 87 with different credit amounts. Here, six of the special symbols 85 are converted into credit symbols 87 with credit amounts of “300”, “10”, “50”, “300”, “10”, and “10”. Then, the control unit 22 displays a vault object 65A in the region 65 of the display 16.

Next, as shown in FIG. 7B, the control unit 22 displays the total credit amount of six of the credit symbols 87 in the vault object 65A. For example, the control unit 22 performs an effect in which the credit amounts from each credit symbol are aggregated into the vault object 65A, and displays the total amount “680” of the credit amounts “300”, “10”, “50”, “300”, “10”, and “10” in the vault object 65A.

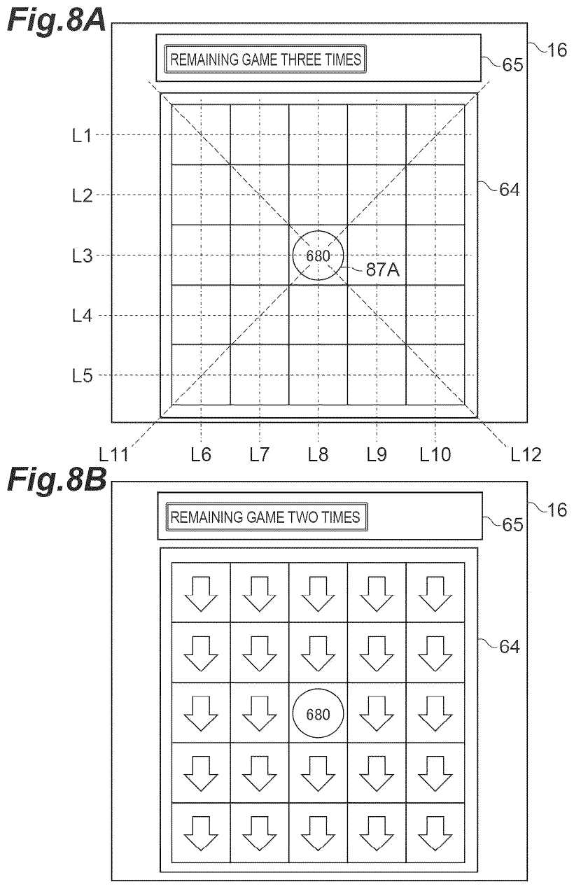

Next, as shown in FIG. 8A, the control unit 22 changes the matrix grid of the symbol display region 64 from 3×5 (3 rows and 5 columns) to 5×5 (5 rows and 5 columns). In the symbol display region 64, win lines are set as in a bingo game. In the case of a 5×5 grid, five horizontal win lines (L1 to L5) each consisting of five horizontally aligned cells, five vertical win lines (L6 to L10) each consisting of five vertically aligned cells, and two diagonal win lines (L11, L12) each consisting of five diagonally aligned cells are set, for a total of twelve win lines. Then, the control unit 22 generates an initial credit symbol 87A whose credit amount is the total amount aggregated in the vault object 65A, and places it in the center cell of the grid. Note that the control unit 22 may generate the initial credit symbol 87A without performing the effect of the vault object 65A, or may place the initial credit symbol 87A in a randomly determined cell. Alternatively, the control unit 22 may store the aggregated total amount in a credit meter or payout meter, etc., without generating the initial credit symbol 87A. Then, the control unit 22 displays the initial value of the remaining number of bonus feature games in the region 65. The initial value is, for example, three.

Next, as shown in FIG. 8B, the control unit 22 executes an action to cause bonus symbol to randomly appear in the blank cells of the symbol display region 64. The action is performed using independent reels provided for each blank cell. The control unit 22 spins the independent reels in each blank cell and decreases the remaining number of games by one and displays it (the remaining number is two).

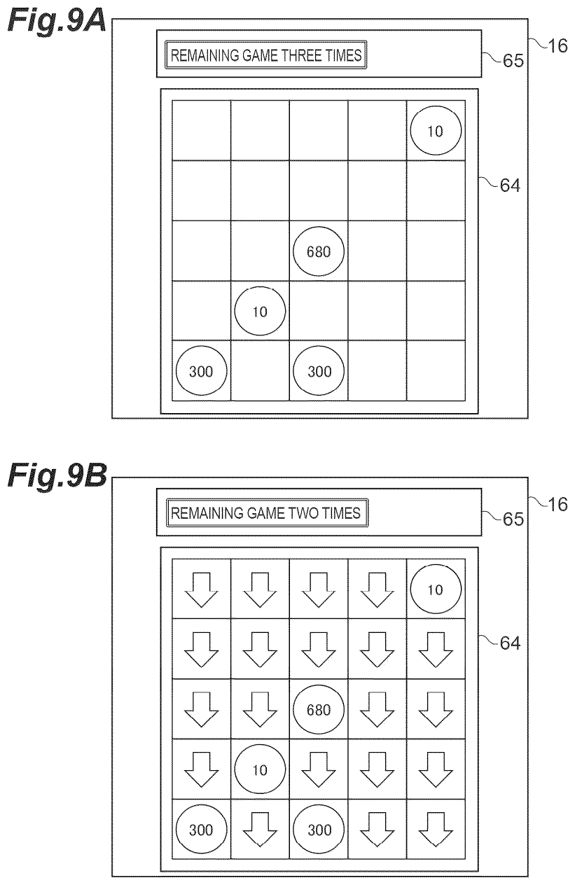

Next, as shown in FIG. 9A, the reel action ends and it is assumed that additional four of bonus symbols have appeared. Here, it is assumed that credit symbol 87 with credit amounts of “300”, “10”, “300”, and “10” have appeared. Since bonus symbol has appeared, the control unit 22 resets the remaining number of games to the initial value (the remaining number is three). Then, since there is no single win line in which all the cells are filled with bonus symbol, the control unit 22 executes the same action again. That is, as shown in FIG. 9B, the control unit 22 spins the independent reels in each blank cell and decreases the remaining number of games by one and displays it (the remaining number is two).

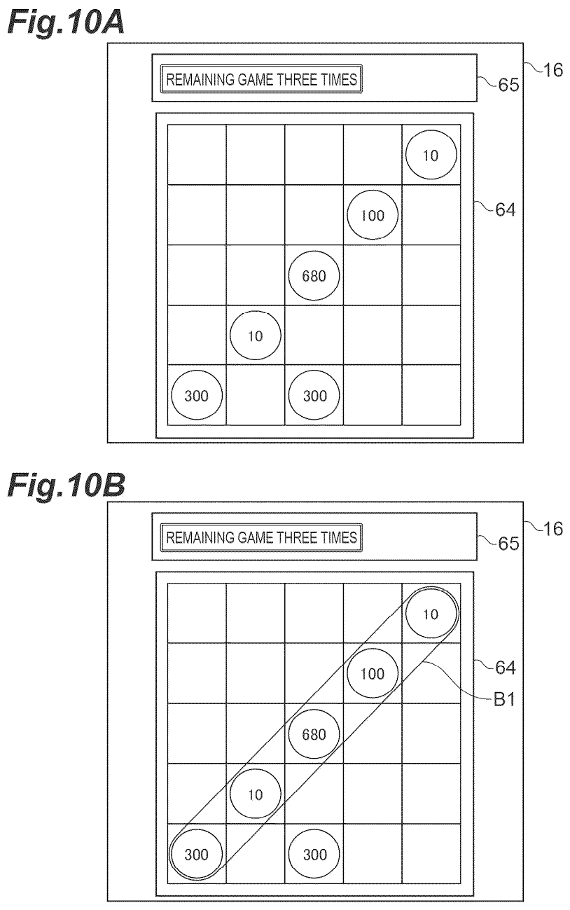

Next, as shown in FIG. 10A, the reel action ends, and it is assumed that one more bonus symbol has appeared. Here, it is assumed that a credit symbol 87 with a credit amount of “100” has appeared. Since a bonus symbol has appeared, the control unit 22 resets the remaining number of games to the initial value (the remaining number is three). Then, since all the cells constituting the single win line L11 are filled with bonus symbols, the control unit 22 executes a bingo win process. The control unit 22 highlights the win line L11 that has achieved bingo. As an example, as shown in FIG. 10B, the win line L11 is highlighted (displayed as B1).

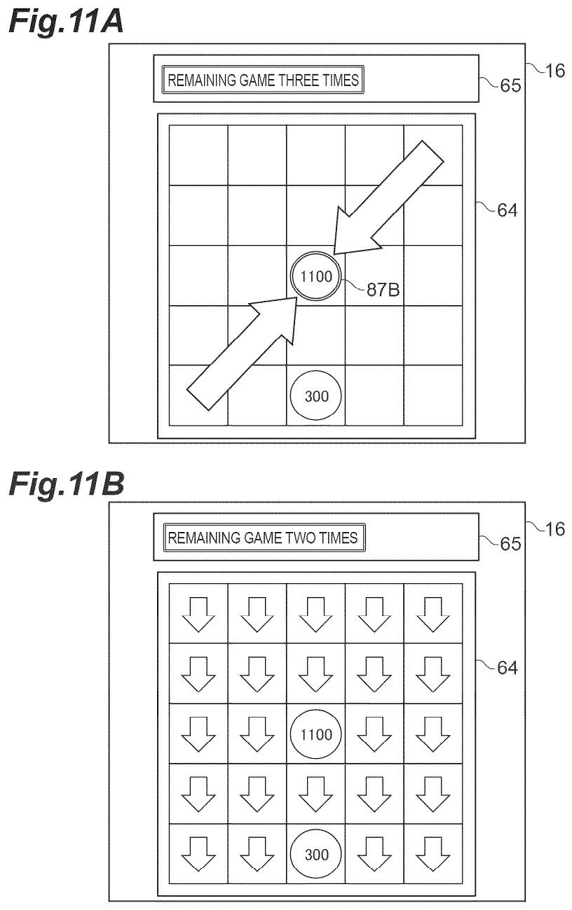

Next, as shown in FIG. 11A, the control unit 22 generates a new specific credit symbol 87B based on the total amount of awards associated with the bonus symbols displayed on the win line L11. As an example, the control unit 22 generates a specific credit symbol 87B with a credit amount of “1100”, which is the total of the credit amounts “300”, “10”, “680”, “100”, and “10” displayed on the win line L11. The control unit 22 holds the specific credit symbol 87B in one of the cells constituting the win line L11. In the example shown in FIG. 10A, the specific credit symbol 87B is held in the center cell of the win line L11. The control unit 22 may perform an effect in which the other credit symbol 87 are moved and aggregated toward the center cell where the specific credit symbol 87B is held, and the specific credit symbol 87B is generated (see the arrows in the figure). Note that the control unit 22 may randomly determine the cell in which the specific credit symbol 87B is held from among the cells constituting the win line L11. Alternatively, the control unit 22 may generate a jackpot symbol corresponding to the total amount instead of the specific credit symbol 87B. Next, as shown in FIG. 11B, the control unit 22 spins the independent reels in each blank cell and decreases the remaining number of games by one and displays it (the remaining number is two).

The control unit 22 repeatedly executes the action until the remaining number of games becomes zero. When the remaining number of games becomes zero, the control unit 22 provides the total amount of awards associated with the credit symbol 87 displayed in the symbol display region 64 to the player. If the remaining number of games becomes zero in the state shown in FIG. 11B, the control unit 22 provides the total amount “1400” of the credit amounts “1100” and “300” to the player. The bonus feature game ends here.

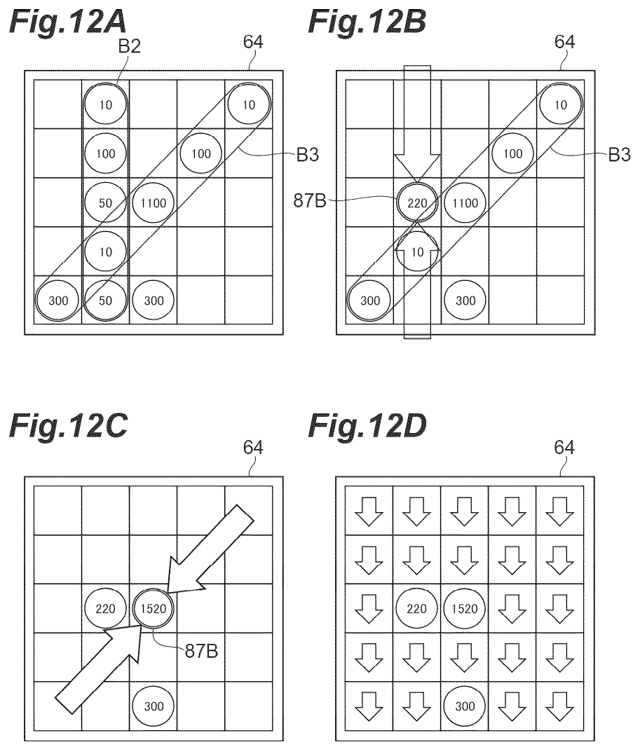

When the control unit 22 executes the action, it is possible that a plurality of win lines are filled with bonus symbols. As shown in FIG. 12A, it is assumed that the win lines L6 and L11 are filled with bonus symbols (displayed as B2 and B3). In this case, the control unit 22 may generate a specific credit symbol 87B for each of the win lines L6 and L11. For example, as shown in FIG. 12B, the control unit 22 generates a specific credit symbol 87B with a credit amount of “220” for the win line L6 and holds the specific credit symbol 87B in the center cell of the win line L6. Next, as shown in FIG. 12C, the control unit 22 generates a specific credit symbol 87B with a credit amount of “1520” for the win line L11 and holds the specific credit symbol 87B in the center cell of the win line L11. Next, as shown in FIG. 12D, the control unit 22 spins the independent reels in each blank cell. In this way, even when a plurality of win lines are filled with bonus symbols, the control unit 22 can generate specific credit symbol 87B.

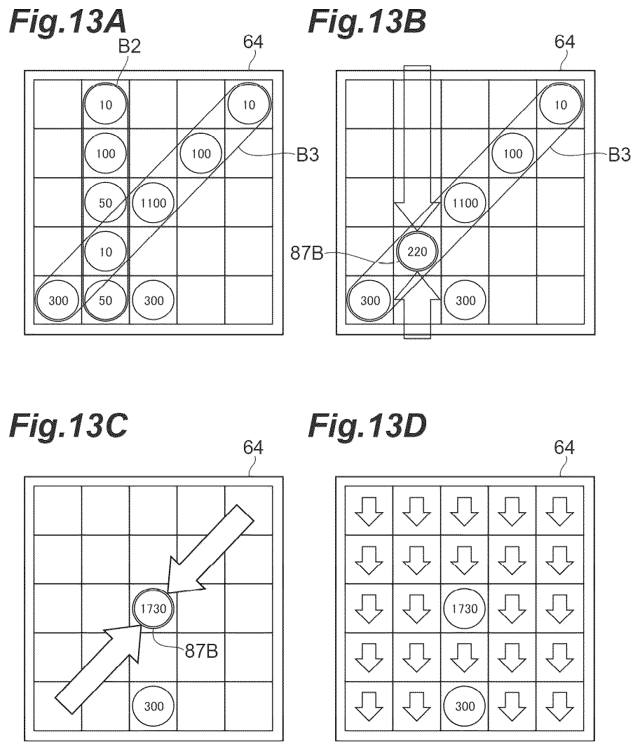

When a plurality of win lines are filled with bonus symbol and those win lines overlap, the position for holding the specific credit symbol 87B may be adjusted to increase the number of blank cells. For example, as shown in FIG. 13A, it is assumed that the win lines L6 and L11 are filled with bonus symbols (displayed as B2 and B3). As shown in FIG. 13B, the control unit 22 generates a specific credit symbol 87B with a credit amount of “220” for the win line L6 and holds the specific credit symbol 87B in the cell that overlaps with the win line L11 among the cells constituting the win line L6. Next, as shown in FIG. 13C, the control unit 22 generates a specific credit symbol 87B with a credit amount of “1730” for the win line L11 and holds the specific credit symbol 87B in the center cell of the win line L11. Next, as shown in FIG. 13D, the control unit 22 spins the independent reels in each blank cell. Compared to the example shown in FIG. 12D, although the total amount displayed in the symbol display region 64 decreases, the number of blank cells can be increased.

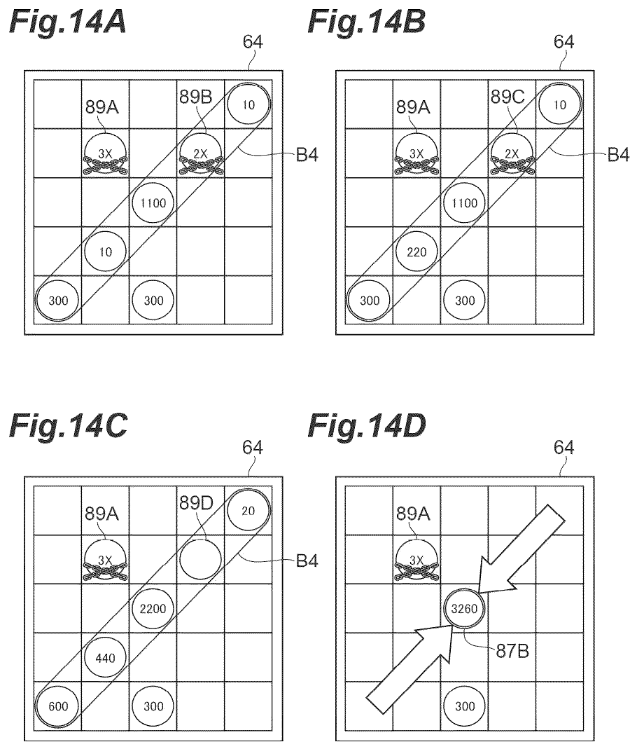

Next, a case will be described in which a multiplier symbol 89 is included in the bonus symbols when a single win line is filled with bonus symbols. As shown in FIG. 14A, it is assumed that the win line L11 is filled with bonus symbols (displayed as B4). It is also assumed that two of multiplier symbols 89A and 89B are held in the symbol display region 64. In this case, the control unit 22 releases the locked state of the multiplier symbol 89B displayed in the cell constituting the win line L11. As a result, as shown in FIG. 14B, the chain 91 of the multiplier symbol 89B is removed, and the multiplier symbol 89B is changed to a multiplier symbol 89C that exerts the effect of the multiplier. The control unit 22 does not release the locked state of the multiplier symbol 89A that is not displayed in the cell constituting the win line L11.

Next, as shown in FIG. 14C, the control unit 22 increases the credit amounts of all the credit symbols held in the cells constituting the win line L11 by the multiplier (here, 2 times) corresponding to the multiplier symbol 89C whose locked state has been released. The credit amounts of the credit symbol held in the cells constituting the win line L11, “300”, “10”, “1100”, and “10”, become “600”, “20”, “2200”, and “20”, and the multiplier symbol 89C becomes a used symbol 89D. Next, as shown in FIG. 14D, the control unit 22 generates a specific credit symbol 87B with a credit amount of “3260” for the win line L11 and holds the specific credit symbol 87B in the center cell of the win line L11. In this way, when a multiplier symbol 89 is included in the bonus symbols at the time a single win line is filled with bonus symbols, the locked state is released and the effect of the multiplier is exerted.

When a plurality of win lines are filled with bonus symbols and those win lines overlap, and a multiplier symbol 89 is displayed at the intersecting position, the control unit 22 may apply the effect of the multiplier to the credit symbols 87 of both intersecting win lines.

If the remaining number of games becomes zero in the state shown in FIG. 14D, the control unit 22 provides the total amount “3560” of the credit amounts “3260” and “300” to the player. Since the multiplier symbol 89A displayed at this time is in a locked state, the effect of the multiplier is not exerted and does not contribute to the award. In this way, in order to exert the effect of the multiplier, it is necessary to win a prize as in a bingo game. By fusing a slot game and a bingo game, a new rule is introduced in which the effect of the multiplier is not exerted just by being displayed, but is exerted at the time of a win.

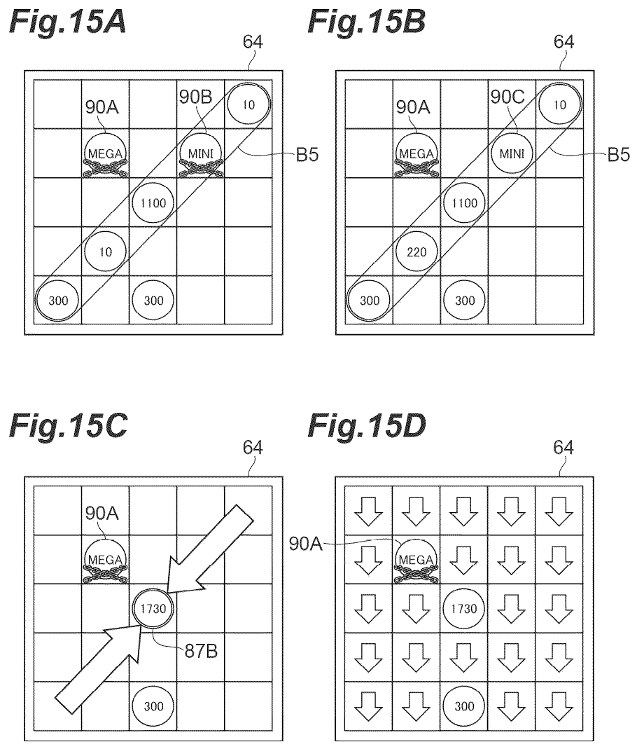

Next, a case will be described in which a jackpot symbol 90 is included in the bonus symbol when a single win line is filled with bonus symbol. As shown in FIG. 15A, it is assumed that the win line L11 is filled with bonus symbols (displayed as B5). It is also assumed that two of jackpot symbols 90A and 90B are held in the symbol display region 64. In this case, the control unit 22 releases the locked state of the jackpot symbol 90B displayed in the cell constituting the win line L11. As a result, as shown in FIG. 15B, the chain 91 of the jackpot symbol 90B is removed, and the jackpot symbol 90B is changed to a jackpot symbol 90C that exerts the effect of the jackpot. The control unit 22 does not release the locked state of the jackpot symbol 90A that is not displayed in the cell constituting the win line L11.

Next, as shown in FIG. 15C, the control unit 22 calculates the credit amount corresponding to the jackpot symbol 90C whose locked state has been released. Here, the credit amount is set to “100”. Then, the control unit 22 aggregates the credit amounts of the credit symbols held in the cells constituting the win line L11, “300”, “10”, “1100”, and “10”, and the credit amount “100” corresponding to the jackpot symbol 90C, and generates a specific credit symbol 87B with a credit amount of “1730” for the win line L11, holding the specific credit symbol 87B in the center cell of the win line L11. In this way, when a jackpot symbol 90 is included in the bonus symbol at the time a single win line is filled with bonus symbols, the locked state is released and the effect of the jackpot is exerted. Next, as shown in FIG. 15D, the control unit 22 spins the independent reels in each blank cell.

When a plurality of win lines are filled with bonus symbols and those win lines overlap, and a jackpot symbol 90 is displayed at the intersecting position, the control unit 22 may apply the effect of the jackpot to the credit symbol 87 of both intersecting win lines.

If the remaining number of games becomes zero in the state shown in FIG. 15D, the control unit 22 provides the total amount “2030” of the credit amounts “1730” and “300” to the player. Since the jackpot symbol 90A displayed at this time is in a locked state, the effect of the jackpot is not exerted and does not contribute to the award. In this way, in order to exert the effect of the jackpot, it is necessary to win a prize as in a bingo game. By fusing a slot game and a bingo game, a new rule is introduced in which the effect of the jackpot is not exerted just by being displayed, but is exerted at the time of a win.

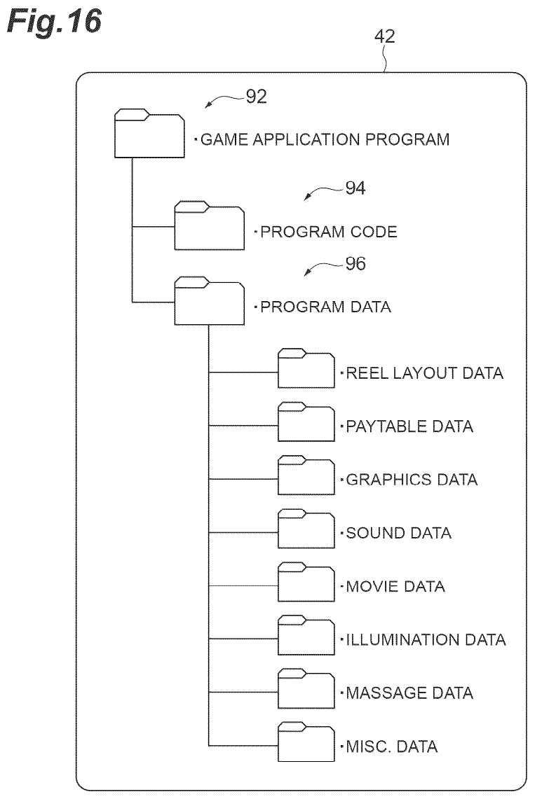

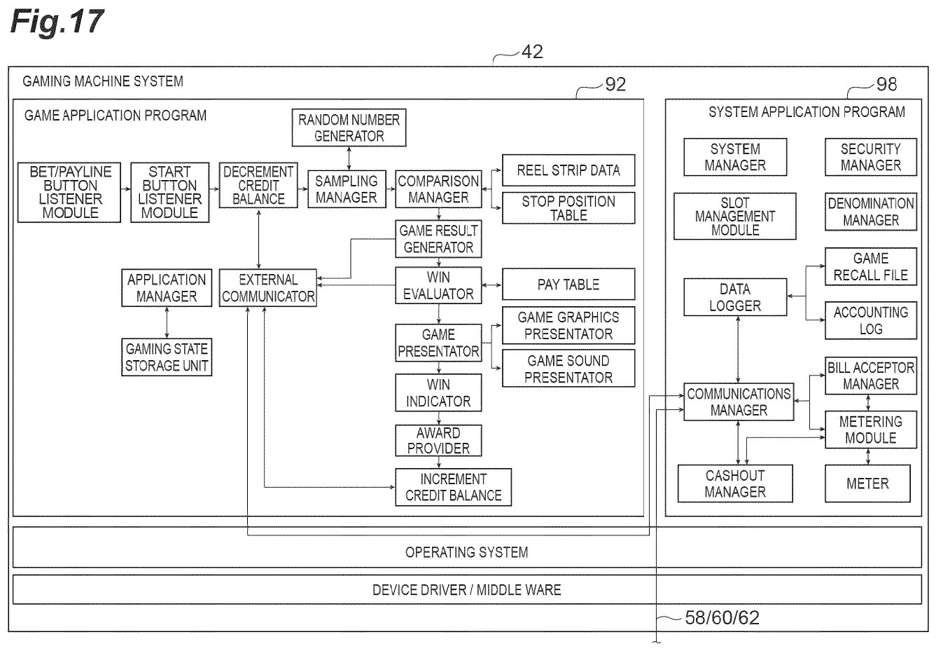

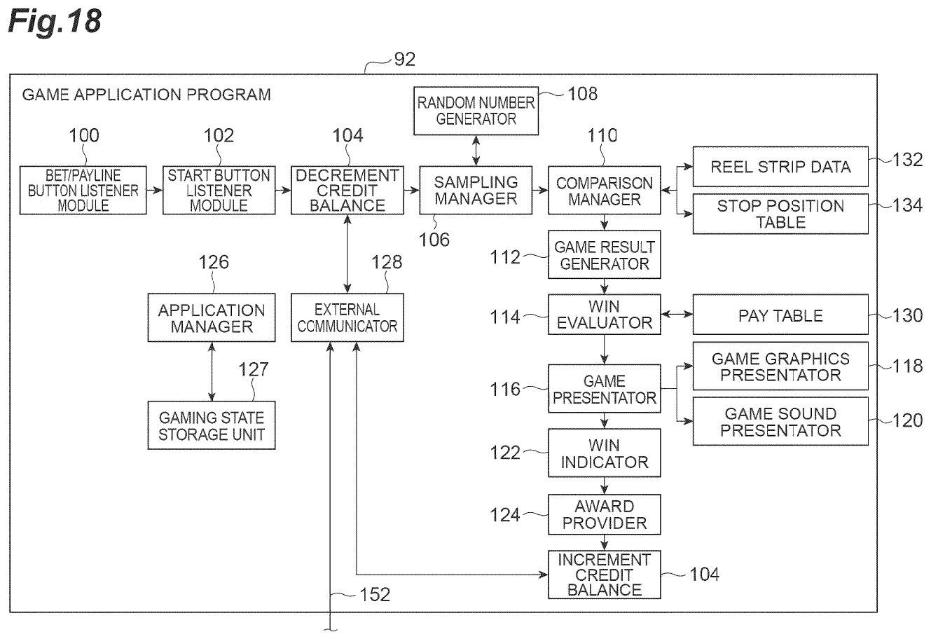

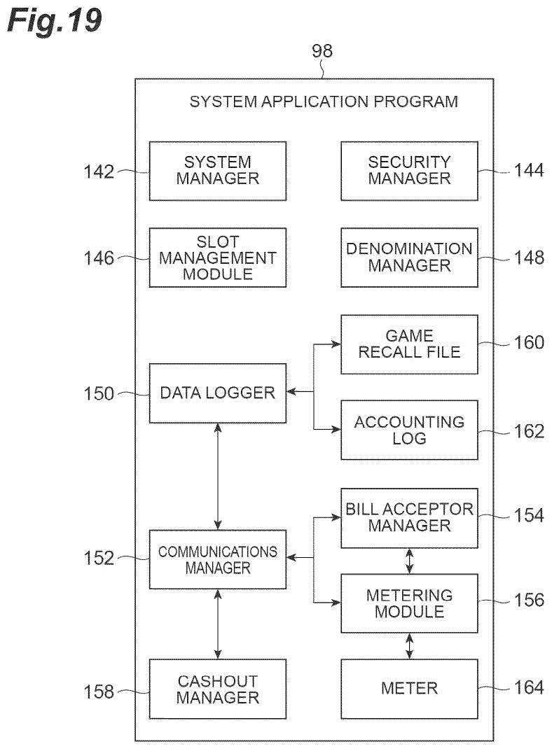

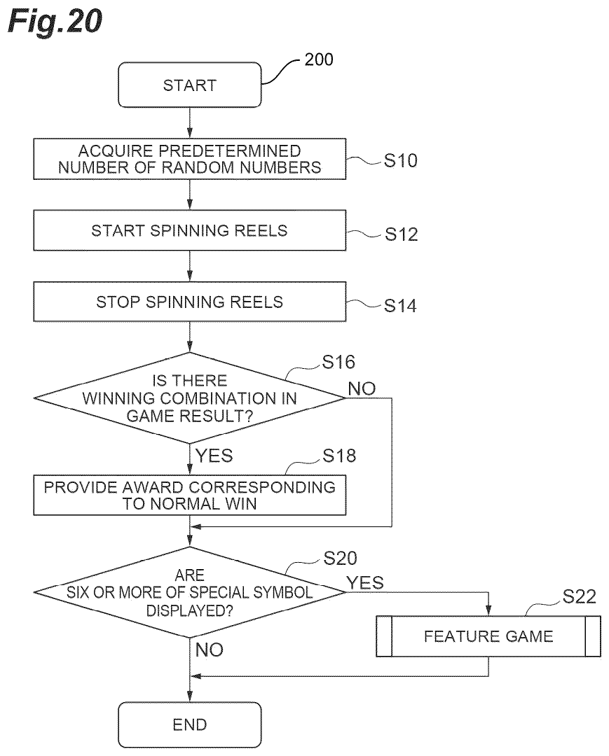

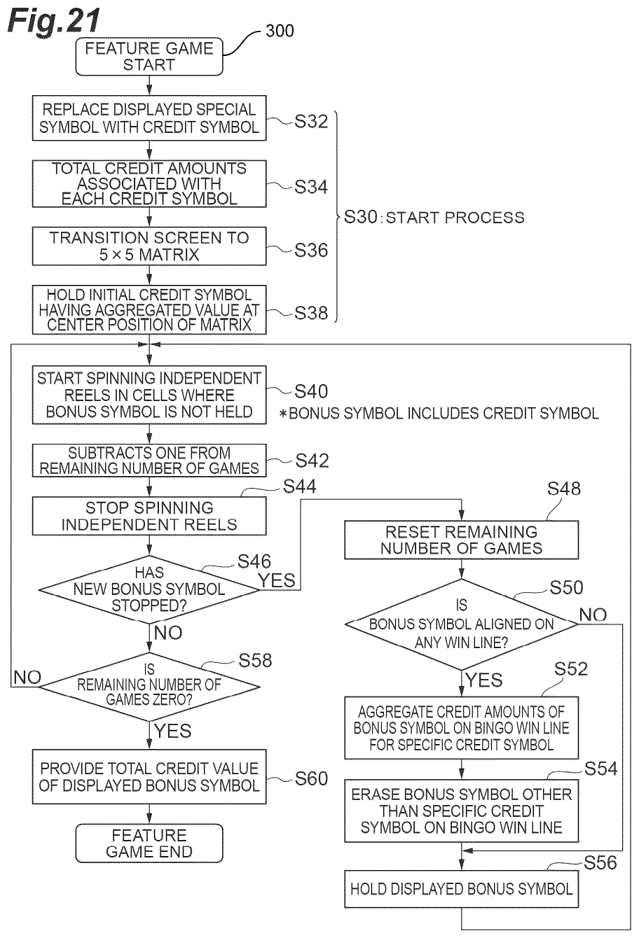

FIGS. 16 and 17 are a directory configuration diagram and a block diagram showing programs and data stored in the memory of FIG. 2. FIG. 18 is a block diagram of the game application program of FIG. 17. FIG. 19 is a block diagram of the system application program shown in FIG. 17. In the embodiments shown in FIGS. 16 to 19, the memory 42 stores a game application program 92 including computer-executable instructions, and processing of the game is performed by executing these computer-executable instructions in CPU 38, and the game screen is displayed on the display 16 in the gaming machine 10. Also, in one embodiment, the game application program 92 includes program code 94 and program object data 96 that include computer-executable instructions for implementing a game using the algorithms shown in FIGS. 20 and 21.

In an exemplary embodiment, the memory 42 stores the game application program 92 and a system application program 98 including computer-executable instructions that are executed in the CPU 38 to process the game and display a game screen on the display 16 of the gaming machine 10. The game application program 92 provides a game-specific front-end function by executing on the CPU, and the system application program 98 provides a generic back-end function. In the illustrated embodiment, the game application program 92 and the system application program 98 are implemented on the same operating system. However, it should be noted that these programs may be implemented on respective operating systems and/or by respective processors.

In one embodiment, the game application program 92 includes a plurality of software modules including a bet/payline button listener module 100, a start button listener module 102, a credit balance manager module 104, a sampling manager 106, a random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, reel strip data 132, and a stop position table 134.

The bet/payline button listener module 100 is a software module for receiving a signal from a bet button of the operation unit 32, the signal being generated by the button when the player operates the button to select a bet amount. In response to receiving the signal, the bet/payline button listener module 100 communicates the occurrence of the signal to the application manager 126 for changing the bet of the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on a predetermined algorithm of computational random generation method. The random number generator 108 may be a pseudorandom number generator. The random number generator 108 returns the random numbers in response to a request from the sampling manager 106. The random number generator 108 may be implemented in part or in whole as an integrated circuit or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for normal games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. In one embodiment, the game result generator 112 may apply a change on the game result when a predetermined condition is satisfied.

The win evaluator 114 evaluates the game result with reference to the pay table 130. To be specific, the winning evaluation is performed based on whether symbols defined as a winning combination in the pay table 130 stop.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbol formed in the game result. The award provider 124 provides award credit to the win meter based on the win evaluation.

The application manager 126 administrates the operation and state of each software module. In addition, the application manager 126 administrates the configuration, progress, and states of the game application program 92. The application manager 126 refers to a gaming state storage unit 127, determines the size of the symbol display region 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides background processing and functions other than game-specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the background processing and functions other than game-specific functions conducted by the system application program 98.

The security manager 144 is a software module for administrating game verification, door security, and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is an accumulated data including the results of each game. The game recall file 160 is stored in non-volatile memory. The accounting log 162 is an accumulated data including error events, bill logs, cashout logs, ticket logs, and the like. The accounting log 162 is stored in non-volatile memory.

The communications manager 152 is a software module for administrating communication between the game application program 92 and the system application program 98. The communications manager 152 also administrates network communications between the system application program 98 and other gaming machines 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot, and/or bill-in. These meters may be implemented as a data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIGS. 20 and 21 flowcharts illustrating algorithms 200 and 300 defined by the computer-executable instructions included in the game application program 92 and performed by the one or more processors 38 when executing the game application program 92 for operating the gaming machine 10 to generate and render animated sequences of computer-generated images on graphic user interface screens to display the game to the player. The algorithms include a plurality of steps. Each algorithm step may be performed independently of, or in combination with, other algorithm steps. Portions of the algorithms may be performed by any one of, or any combination of, the components of the gaming machine 10.

For example, the game application program 92 may include computer-executable instructions defining algorithms for providing the Bingo Frenzy Stampede™ slot games offered by Konami Gaming™ Inc.

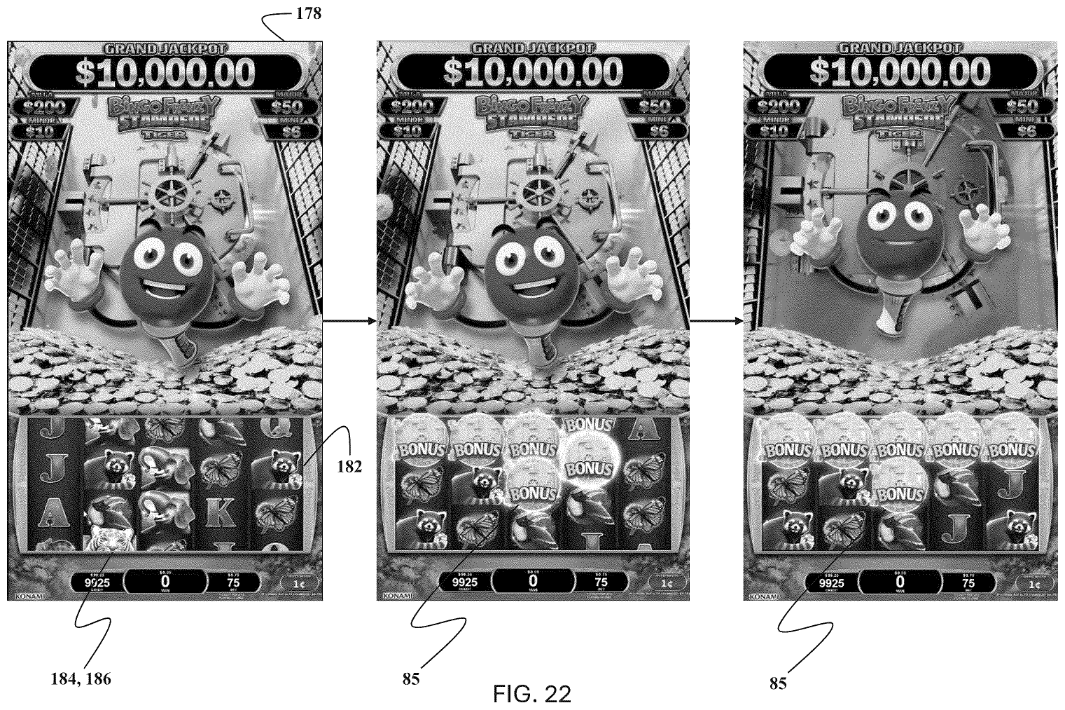

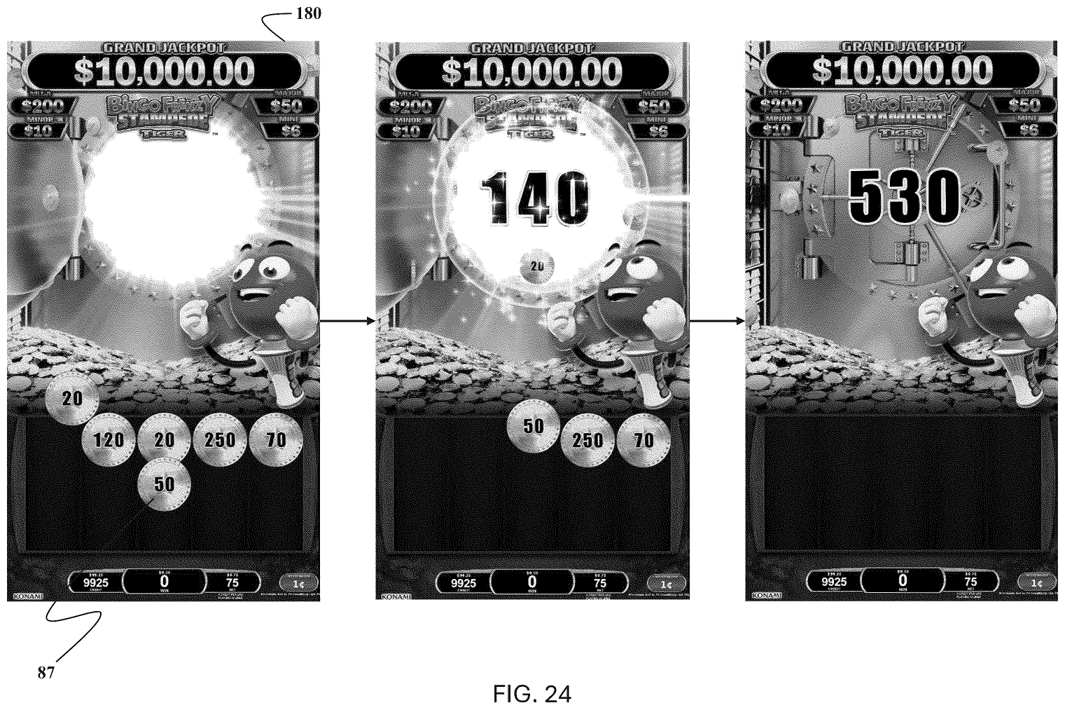

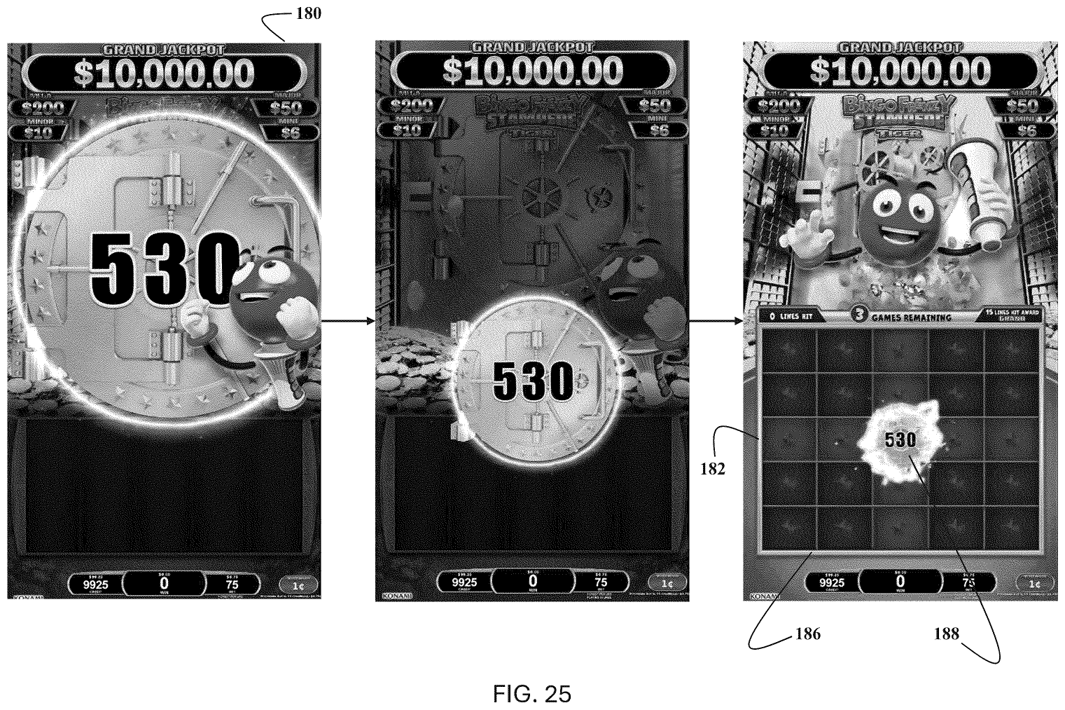

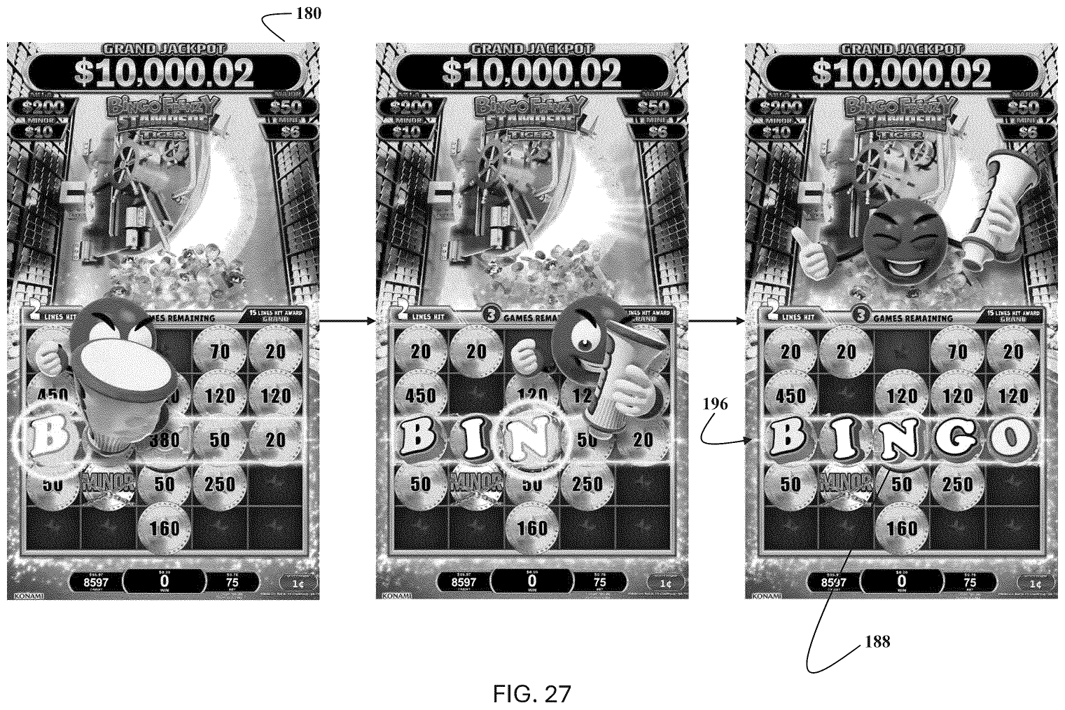

In the illustrated embodiment, the game application program 92 includes computer-executable instructions for executing the algorithms 200 and 300 for rendering animated sequences of computer-generated images displaying a primary game 178 (shown in FIGS. 22-24) and a bonus feature bingo-type game 180 (shown in FIGS. 25-32). In general, the bonus feature bingo-type game 180 is executed when a triggering event is detected during the primary game 178. In one embodiment, the primary game 178 includes a reel-type game that includes a plurality of virtual reels that spin and stop to display the outcomes of the primary game.

For example, in step S10 of algorithm 200, the control unit 22 receives a game start operation by the player, and upon receiving an operation of the spin button from the player, subtracts the set total bet amount from the credit and acquires a predetermined number of random numbers required to provide the game. The random numbers are generated internally in the random number generator 108 of the control unit 22. The control unit 22 may acquire the random numbers from a random number generator provided separately from the control unit 22, or may acquire the random numbers from devices such as servers provided outside the gaming machine 10.

The control unit 22 starts spinning a plurality of reels as step S12. Next, the control unit 22 stops spinning the plurality of reels as step S14. The control unit 22 determines the symbol combination as the game result and determines whether the symbol combination has a winning combination as step S16. If it is determined that there is a win (step S16: YES), the control unit 22 provides an amount corresponding to the win as an award as step S18 (normal win). For example, the control unit 22 adds the amount corresponding to the win to the held credit. If it is determined that there is no win (step S16: NO), no award is provided.

Subsequently, the control unit 22 determines whether a bonus feature game has been triggered as step S20. The control unit 22 determines that a bonus feature game has been triggered if six or more of special symbol 85 are displayed. If it is determined that a bonus feature game has been triggered (step S20: YES), the control unit 22 executes feature processing as step S22. When step S22 ends, or if it is determined that a bonus feature game has not been triggered (step S20: NO), the flowchart shown in FIG. 20 ends.

For example, as shown in FIG. 22, in the illustrated embodiment, the one or more processors 38 of the control unit 22 accesses the virtual reel set data file 170 and the symbol image data file 172, and executes the computer-executable instructions contained therein to render the game screen on the display device GUI 16 including a plurality of cells 182 displayed in a primary game grid 184 including a plurality of rows and a plurality of columns arranged in a 3×5 matrix. The plurality of primary game reels 72-80 are displayed within the primary game grid 184 with each primary game reel 72-80 being displayed in a corresponding column.

The one or more processors 38 then animate the plurality of primary game reels 72-80 to spin through the primary game grid 184 and sequentially stop to display a plurality of game symbols 84 and a plurality of feature trigger symbols 85 within the primary game grid 184. For example, the one or more processors 38 may spin and stop the primary game reels 72-80 to display six feature trigger symbols 85 within the primary game grid 184, before displaying the bonus feature bingo-type game 180.

Next, the bonus feature game processing will be described. The flowchart shown in FIG. 21 is a detailed view of the feature processing in FIG. 20.

As shown in FIG. 21, first, the control unit 22 executes a start process as step S30 of algorithm 300. More specifically, as step S32, the control unit 22 replaces the displayed special symbol 85 with credit symbol 87 (see FIG. 7A). Subsequently, as step S34, the control unit 22 totals the credit amounts associated with each credit symbol 87 (see FIG. 7B). Next, as step S36, the control unit 22 transitions the screen to a 5×5 matrix (see FIG. 8A). Then, as step S38, the control unit 22 displays and holds an initial credit symbol 87A having the aggregated value at the center position of the matrix (see FIG. 8A).

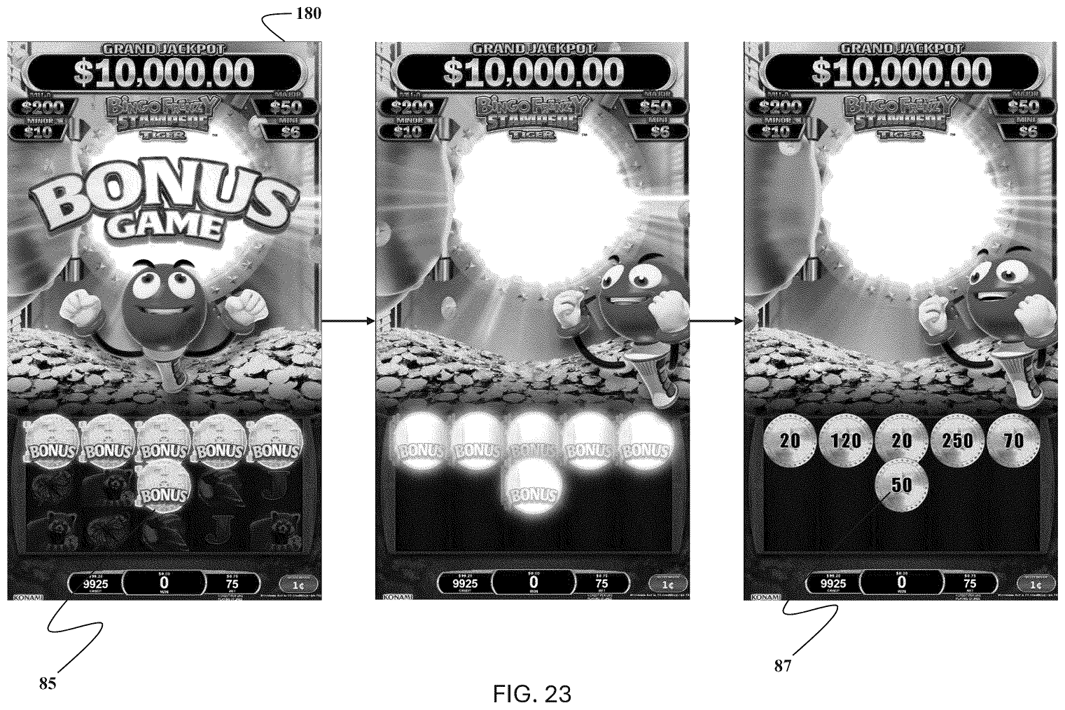

For example, as shown in FIGS. 23-25, in the illustrated embodiment, the one or more processors 38 of the control unit 22 animate a bingo-type bonus feature 180 to appear on the GUI 16 by animating each displayed feature trigger symbol 85 to display a corresponding credit amount 87, animating the primary game grid 184 to transform into a bonus feature game grid 186 including a second plurality of cells 182 arranged in a 5×5 matrix, and animating a bonus feature symbol 188 to appear in a center cell of the 5×5 matrix displaying a initial credit amount (e.g., shown as “530” in FIG. 25) equal to a sum of the credit amounts displayed with the feature trigger symbols 85. The 5×5 matrix defines twelve winning lines (e.g., L1-L12 shown in FIG. 8A) including five horizontal winning lines, five vertical winning lines, and 2 diagonal winning lines. The one or more processors 38 also access the bonus virtual reel strip data file 174 and the bonus symbol image data file 176 to generate a plurality of independent unisymbol reels 190 including a plurality of null symbols 192 and at least one credit prize symbol 194 displaying a credit value. The one or more processors 38 initially display the plurality of independent unisymbol reels 190 within each other cell of the bonus feature game grid 186 displaying a null symbol 192.

When the start process of step S30 ends, the bonus feature game is provided. As step S40, the control unit 22 starts spinning the independent reels in the cells where bonus symbol is not held (see FIG. 8B). Next, as step S42, the control unit 22 subtracts one from the remaining number of games, and as step S44, stops spinning the independent reels (see FIG. 9A). As step S46, the control unit 22 determines whether a new bonus symbol has stopped.

If it is determined that a new bonus symbol has stopped (step S46: YES), the control unit 22 resets the remaining number of games as step S48. Subsequently, as step S50, the control unit 22 determines whether bonus symbol is aligned on any win line. If it is determined that bonus symbol is aligned on any win line (step S50: YES), the control unit 22 generates and holds a specific credit symbol 87B that aggregates the credit amounts of the bonus symbol on the bingo win line as step S52 (see FIG. 11A). If a multiplier symbol 89 is included in the bonus symbol, the control unit 22 applies the effect of the multiplier to generate the specific credit symbol 87B (see FIGS. 14A to 14D). If a jackpot symbol 90 is included in the bonus symbol, the control unit 22 applies the effect of the jackpot to generate the specific credit symbol 87B (see FIGS. 15A to 15C).

Subsequently, as step S54, the control unit 22 erases bonus symbol other than the specific credit symbol 87B on the bingo win line. As a result, the cells that were filled with bonus symbol become blank cells. When step S54 ends, or if it is determined that bonus symbol is not aligned on any win line (step S50: NO), the control unit 22 holds the displayed bonus symbol as step S56. Next, the control unit 22 returns to step S40 and executes the above action again. In this way, the processing from step S40 to step S56 is repeatedly executed until new bonus symbol no longer stop.

If it is determined that no new bonus symbol has stopped (step S46: NO), the control unit 22 determines whether the remaining number of games is zero as step S58. If it is determined that the remaining number of games is not zero (step S58: NO), the control unit 22 returns to step S40 and executes the above action again. In this way, the processing from step S40 to step S58 is repeatedly executed until the remaining number of games becomes zero.

If it is determined that the remaining number of games is zero (step S58: NO), the control unit 22 provides the total credit value of the displayed bonus symbol as an award as step S60. When step S60 ends, the feature processing shown in FIG. 21 ends.

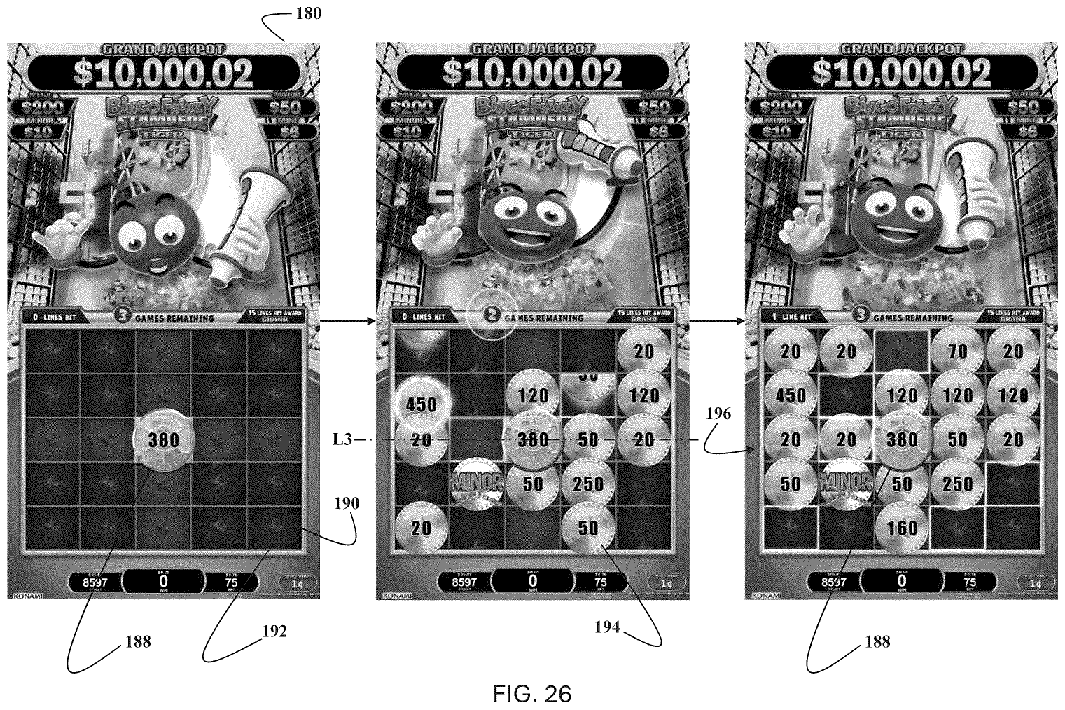

For example, as shown in FIGS. 26-29, in the illustrated embodiment, the one or more processors 38 execute an instance of the bingo-type bonus feature 180 by spinning and stopping the plurality of independent unisymbol reels 190 to display a group 196 of credit prize symbols 194 arranged along a winning line (e.g., L3) extending through the bonus feature symbol 188, with the bonus feature symbol 188 appearing as a bank vault icon and each credit prize symbol 194 appearing as a coin icon.

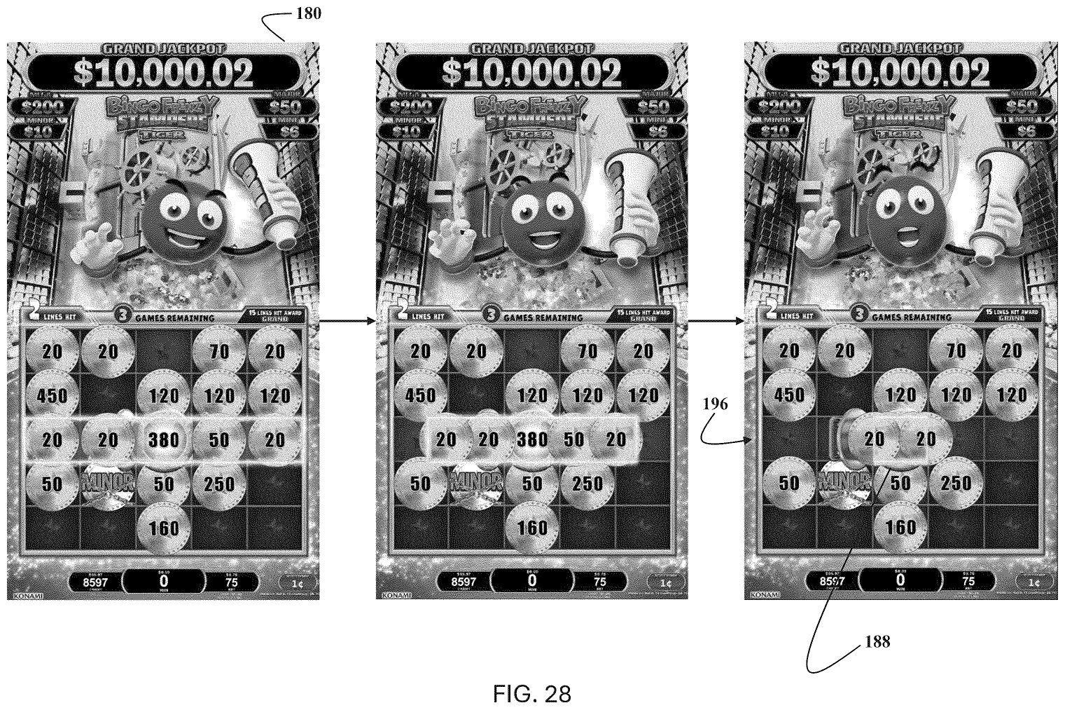

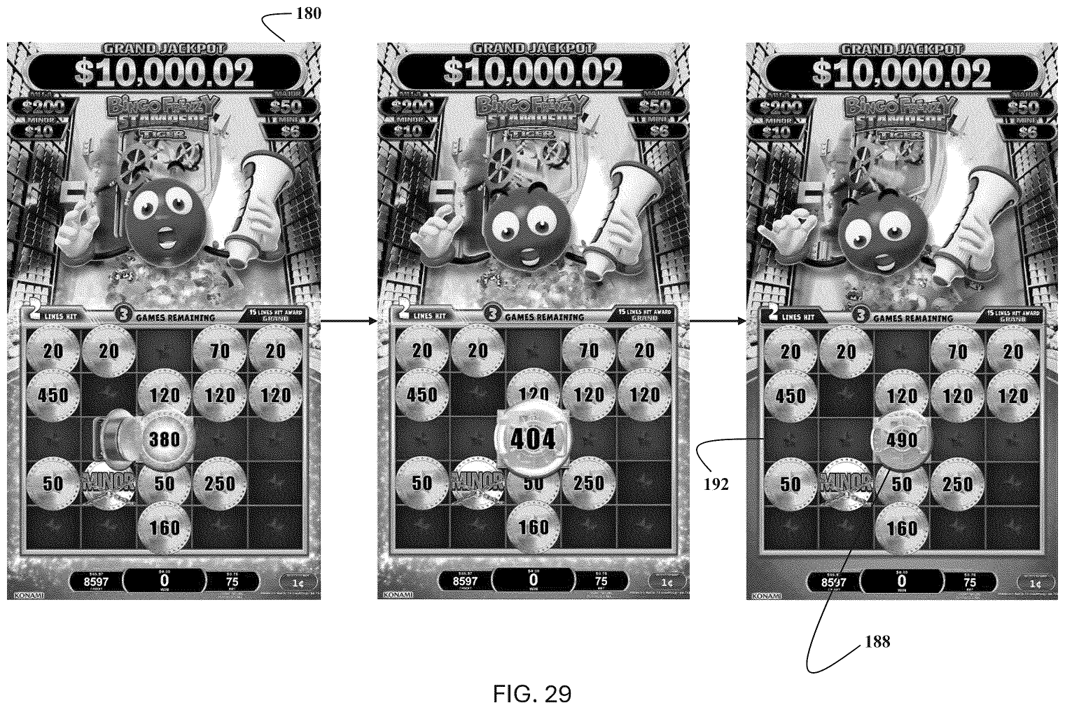

The one or more processors 38 then animate letter icons “B I N G O” to overlay across the group 196 of credit prize symbols and the bonus feature symbol 188 prior to collapsing the group 196 of credit prize symbols 194 into the bonus feature symbol 188, then animate the group 196 of credit prize symbols 194 to collapse into the bonus feature symbol 188 and modify the bonus feature symbol 188 to display an updated credit amount (e.g., shown as “490” in FIG. 29) equal to a sum of the credit values displayed with the group of credit prize symbols 194 arranged along the winning line and the initial credit amount. For example, the bank vault icon 188 is animated as an open bank vault door as the coin icons 194 move into the bank vault icon 188 as the updated credit amount adjusts to show an increasing credit amount. The animated bank vault door then closes as the updated credit amount is overlayed across the bank vault icon 188. As shown in FIGS. 28-29, the one or more processors 38 also replace the group 196 of credit prize symbols 194 with null symbols 192 displayed in vacated cells 182 as the group 196 of credit prize symbols 194 collapses into the bonus feature symbol 188.

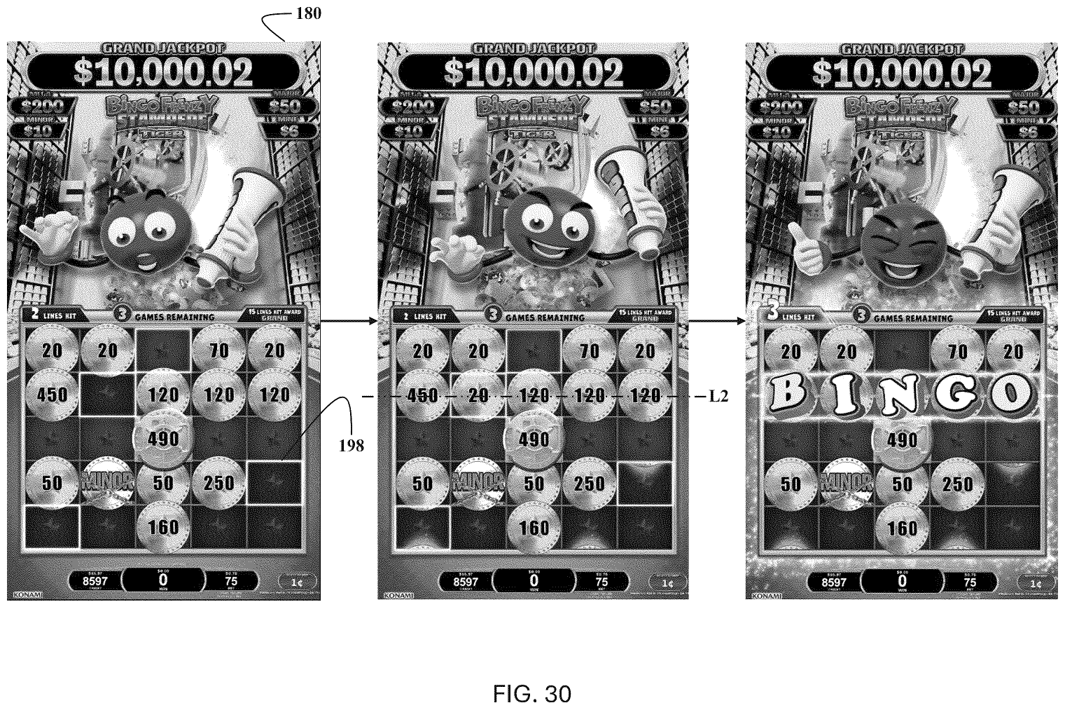

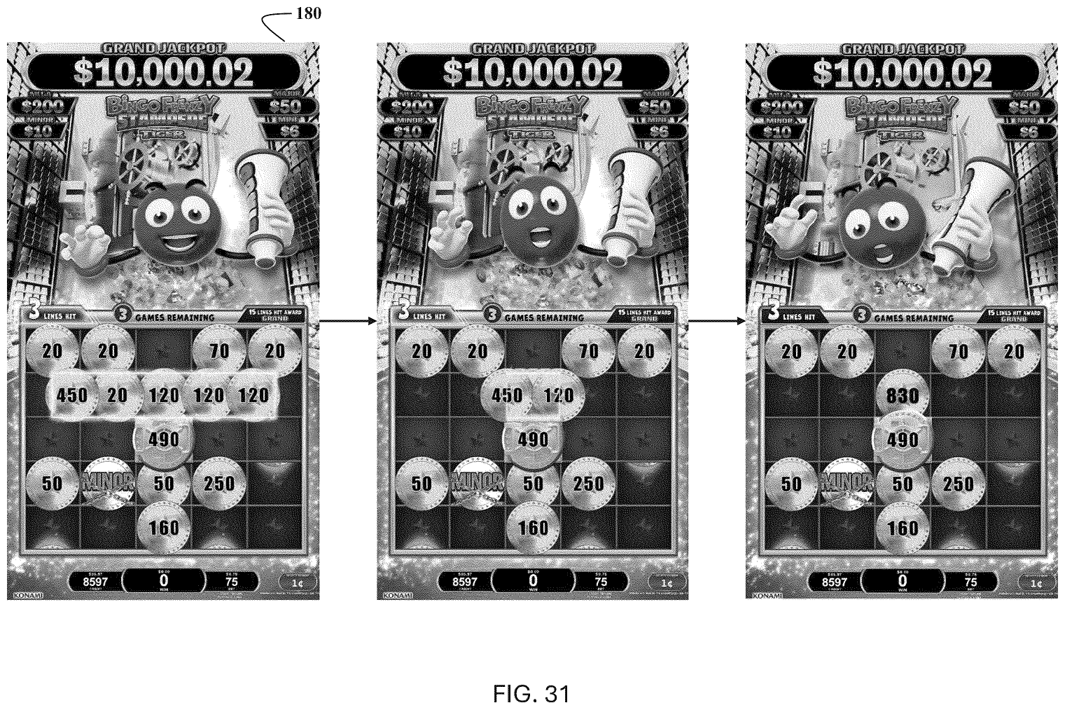

As shown in FIGS. 30-31, the one or more processors 38 then execute a subsequent instance of the bingo-type bonus feature 180 by identifying independent unisymbol reels 190 displaying null symbols 192, identifying winning lines displaying only one null symbol 192 and animating a frame icon 198 to appear around a corresponding cell displaying the only one null symbol 192 along a winning line.

The one or more processors 38 then spins and stops the selected independent unisymbol reels 190 to display a second group 199 of credit prize symbols 194 arranged along a second winning line (e.g. L2) that does not extend through the bonus feature symbol 188, and animates the letter icons “B I N G O” to overlay across the second group 199 of credit prize symbols 194 such that the letter icon “N” overlays a center credit prize symbol 194 of the second group 199 of credit prize symbols 194. The one or more processors 38 then animates the second group 199 of credit prize symbols to collapse into the center credit prize symbol 194 and modifies the center credit prize symbol 194 to display an updated credit value equal to a sum of the credit values displayed with the second group 199 of credit prize symbols 194.

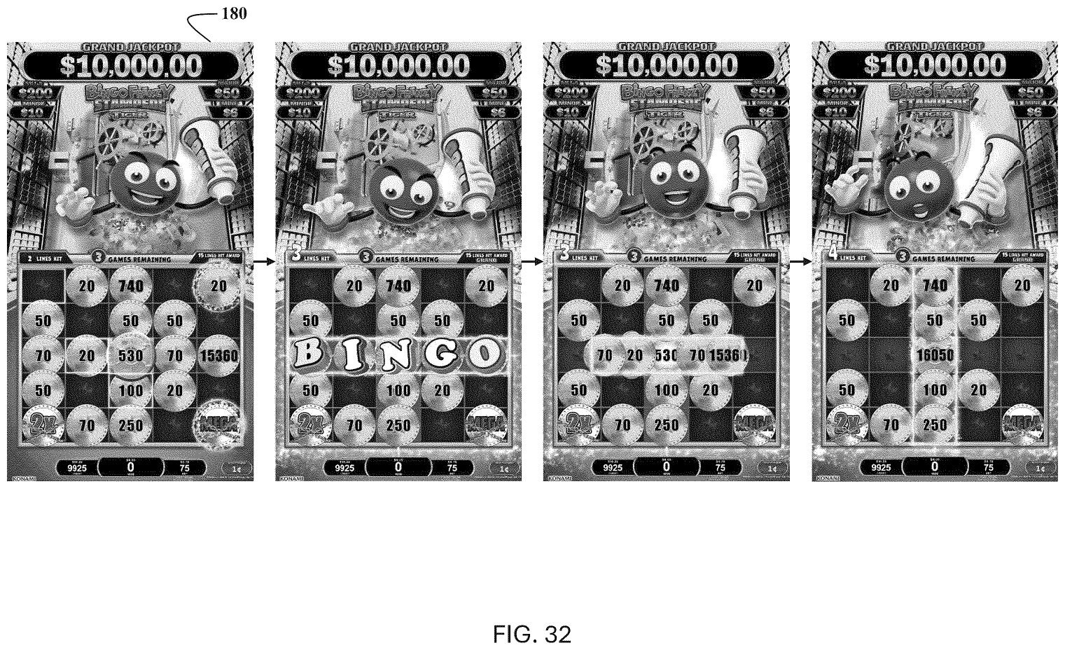

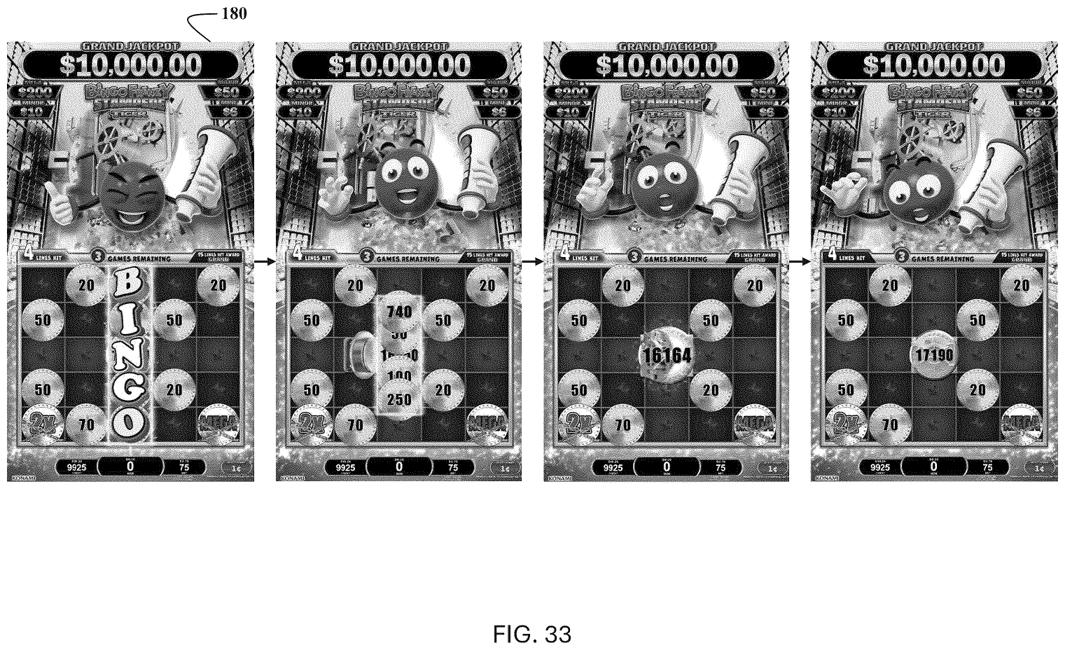

In some embodiments, the one or more processors 38 may execute an instance of the bingo-type bonus feature 180 to display two or more groups of credit prize symbols 194 arranged along different winning lines that extend through the bonus feature symbol 188. For example, as shown in FIGS. 32-33, the one or more processors 38 may spin and stop the plurality of independent unisymbol reels 190 to display a first group of credit prize symbols 194 arranged along a first winning line (e.g., L3) extending through the bonus feature symbol 188 and to display a different group of credit prize symbols 194 arranged along a different winning line (e.g., L8) extending through the bonus feature symbol 188. The one or more processors 38 then animates the letter icons “B I N G O” to overlay across the first group of credit prize symbols 194 such that the letter icon “N” overlays the bonus feature symbol 188, and then animates the first group of credit prize symbols 194 to collapse into the bonus feature symbol 188 and modifies the bonus feature symbol 188 to display the updated credit amount. The one or more processors 38 then animates the letter icons “B I N G O” to overlay across the different group of credit prize symbols 194 such that the letter icon “N” overlays the bonus feature symbol 188, then animates the different group of credit prize symbols 194 to collapse into the bonus feature symbol 188 and modifies the bonus feature symbol 188 to display a second updated credit amount equal to a sum of the credit values displayed with the different group of credit prize symbols 194 and the updated credit amount.

As described above, in the gaming machine 10, an action is executed in which bonus symbol randomly appear in the blank cells of the symbol display region 64. After execution of the action, the displayed bonus symbol is held in their respective cells, and the cells in which bonus symbol have not been displayed become blank cells, and the above action is executed again. The bonus symbol are associated with an amount of award, and the total amount of awards associated with the displayed bonus symbol is provided to the player after the end of the game. Here, when all the cells constituting a single win line are filled with bonus symbol, the same state as a win (bingo) in a bingo game is achieved. In such a state, a new specific credit symbol 87B is generated based on the total amount of awards associated with the bonus symbol displayed on the single win line. The specific credit symbol 87B is held in one of the cells constituting the single win line, and the remaining cells constituting the single win line become blank cells. In this way, the bonus symbol that filled the single win line are represented by a single specific credit symbol 87B, and the remaining cells are returned to blank cells. As a result, the above action is executed again for a larger number of blank cells. Here, in the gaming machine 10, the more blank cells there are, the higher the probability that bonus symbol will be displayed. Therefore, after securing the amount of award obtained by achieving the bingo state, it is possible to provide a game state in which the possibility of acquiring awards is increased by increasing the number of blank cells. In addition, by returning the remaining cells to blank cells as described above, it is possible to avoid the situation where all the cells in the symbol display region 64 are filled and the game ends, thus allowing for longer play. Furthermore, it is possible for a line that has once achieved a bingo state to achieve a bingo state again, or for a line that is just before a bingo state (one more to go state) to have the bonus symbol removed and the reach state canceled. In this way, the gaming machine 10 introduces a new function of changing the game state upon achieving a bingo state, and introduces new rules that can result in re-bingo or cancellation of the one more to go state, thereby providing a game development full of changes. Therefore, the gaming machine 10 can provide a novel game that fuses elements of a bingo game and a slot game, and sufficiently provides new stimulation and excitement to players by new rules.

The gaming machine 10 may be a client computing device, in which case the game is delivered from a network-server computer system to one or more client computing devices via a communication network. The processor of the client computing device may be programmed to function as the control unit 22 of the gaming machine 10.

When the gaming machine 10 is used as a client computing device, (1) a rich client system may be used in which most of the processing involved in game execution is performed on the client side and results are transmitted to the server, (2) a thin-client system may be used in which only minimum processing is performed on the client side and main processing is performed on the server side, and (3) a zero client system may be used in which most of data storage and processing is performed on the server side and the client specializes in input and output. In this case, the software configuration described in the embodiment is distributed and implemented in the client and the server.

In the above-described embodiment, a game that fuses elements of a bingo game and a slot game is provided as a bonus feature game, but it may also be provided as a normal game (main game or base game).

The function of the control unit 22 of the gaming machine 10 described above can also be realized by executing a program by a computer. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there's a power source anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game doesn't proceed after power restoration. However, by collectively acquiring all random numbers at the start of the game and storing these numbers in the memory 42 or the storage 44 as described above, it's possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

A controller, control unit, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable, and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A gaming machine for displaying a computer-animated reel game, comprising:
a cabinet;
a display device mounted to the cabinet and including graphical user interface (GUI) displaying computer-generated images thereon; and
a control unit operably coupled to the display device, the control unit including one or more processors programmed to execute an algorithm to display an animated sequence of computer-generated images on the display device GUI including the steps of:
rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column;
animating the plurality of primary game reels to spin through the primary game grid and sequentially stop to display a plurality of game symbols and a plurality of feature trigger symbols within the primary game grid; and
animating a bingo-type bonus feature to appear on the GUI by:
animating each displayed feature trigger symbol to display a corresponding credit amount;
animating the primary game grid to transform into a bonus feature game grid including a second plurality of cells arranged in a 5×5 matrix;
animating a bonus feature symbol to appear in a center cell of the 5×5 matrix displaying a initial credit amount equal to a sum of the credit amounts displayed with the feature trigger symbols;
generating a plurality of independent unisymbol reels including a plurality of null symbols and at least one credit prize symbol displaying a credit value and initially displaying the plurality of independent unisymbol reels within each other cell of the bonus feature game grid displaying a null symbol; and
executing an instance of the bingo-type bonus feature by:
spinning and stopping the plurality of independent unisymbol reels to display a group of credit prize symbols arranged along a winning line extending through the bonus feature symbol;
animating the group of credit prize symbols to collapse into the bonus feature symbol; and
modifying the bonus feature symbol to display an updated credit amount equal to a sum of the credit values displayed with the group of credit prize symbols arranged along the winning line and the initial credit amount.

2. The gaming machine of claim 1, wherein the one or more processors is programmed to execute the algorithm including the steps of:
replacing the group of credit prize symbols with null symbols displayed in vacated cells as the group of credit prize symbols collapses into the bonus feature symbol.

3. The gaming machine of claim 2, wherein the one or more processors is programmed to execute the algorithm including the steps of:
animating the bonus feature symbol to appear as a bank vault icon; and
animating each credit prize symbol to appear as a coin icon.

4. The gaming machine of claim 3, wherein the one or more processors is programmed to execute the algorithm including the steps of:
animating letter icons “B I N G O” overlayed across the group of credit prize symbols and the bonus feature symbol prior to collapsing the group of credit prize symbols into the bonus feature symbol.

5. The gaming machine of claim 4, wherein the one or more processors is programmed to execute the algorithm including the steps of:
executing a subsequent instance of the bingo-type bonus feature by:
identifying independent unisymbol reels displaying null symbols;
identifying winning lines displaying only one null symbol and animating a frame icon to appear around a corresponding cell displaying the only one null symbol;
spinning and stopping the selected independent unisymbol reels to display a second group of credit prize symbols arranged along a second winning line that does not extend through the bonus feature symbol;
animating the letter icons “B I N G O” overlayed across the second group of credit prize symbols such that the letter icon “N” overlays a center credit prize symbol of the second group of credit prize symbols; and
animating the second group of credit prize symbols to collapse into the center credit prize symbol and modifying the center credit prize symbol to display an updated credit value equal to a sum of the credit values displayed with the second group of credit prize symbols.

6. The gaming machine of claim 1, wherein the one or more processors is programmed to execute the algorithm including the steps of:
animating the bonus feature game grid including the second plurality of cells arranged in a 5×5 matrix defining twelve winning lines including five horizontal winning lines, five vertical winning lines, and 2 diagonal winning lines.

7. The gaming machine of claim 6, wherein the one or more processors is programmed to execute the algorithm including the steps of:
spinning and stopping the plurality of independent unisymbol reels to display the group of credit prize symbols arranged along the winning line extending through the bonus feature symbol and to display a different group of credit prize symbols arranged along a different winning line extending through the bonus feature symbol;
animating the group of credit prize symbols to collapse into the bonus feature symbol and modifying the bonus feature symbol to display the updated credit amount; and
animating the different group of credit prize symbols to collapse into the bonus feature symbol and modifying the bonus feature symbol to display a second updated credit amount equal to a sum of the credit values displayed with the different group of credit prize symbols and the updated credit amount.

8. A method of operating a gaming machine for displaying a computer-animated reel game, the gaming machine including a cabinet, a display device mounted to the cabinet and including graphical user interface (GUI) displaying computer-generated images thereon, and a control unit including one or more processors operably coupled to the display device, the method including the one or more processors performing an algorithm to display an animated sequence of computer-generated images on the display device GUI including the steps of:
rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column;
animating the plurality of primary game reels to spin through the primary game grid and sequentially stop to display a plurality of game symbols and a plurality of feature trigger symbols within the primary game grid; and
animating a bingo-type bonus feature to appear on the GUI by:
animating each displayed feature trigger symbol to display a corresponding credit amount;
animating the primary game grid to transform into a bonus feature game grid including a second plurality of cells arranged in a 5×5 matrix;
animating a bonus feature symbol to appear in a center cell of the 5×5 matrix displaying a initial credit amount equal to a sum of the credit amounts displayed with the feature trigger symbols;
generating a plurality of independent unisymbol reels including a plurality of null symbols and at least one credit prize symbol displaying a credit value and initially displaying the plurality of independent unisymbol reels within each other cell of the bonus feature game grid displaying a null symbol; and
executing an instance of the bingo-type bonus feature by:
spinning and stopping the plurality of independent unisymbol reels to display a group of credit prize symbols arranged along a winning line extending through the bonus feature symbol;
animating the group of credit prize symbols to collapse into the bonus feature symbol; and
modifying the bonus feature symbol to display an updated credit amount equal to a sum of the credit values displayed with the group of credit prize symbols arranged along the winning line and the initial credit amount.

9. The method of claim 8, including the one or more processors performing the algorithm including the steps of:
replacing the group of credit prize symbols with null symbols displayed in vacated cells as the group of credit prize symbols collapses into the bonus feature symbol.

10. The method of claim 9, including the one or more processors performing the algorithm including the steps of:
animating the bonus feature symbol to appear as a bank vault icon; and
animating each credit prize symbol to appear as a coin icon.

11. The method of claim 10, including the one or more processors performing the algorithm including the steps of:
animating letter icons “B I N G O” overlayed across the group of credit prize symbols and the bonus feature symbol prior to collapsing the group of credit prize symbols into the bonus feature symbol.

12. The method of claim 11, including the one or more processors performing the algorithm including the steps of:
executing a subsequent instance of the bingo-type bonus feature by:
identifying independent unisymbol reels displaying null symbols;
identifying winning lines displaying only one null symbol and animating a frame icon to appear around a corresponding cell displaying the only one null symbol;
spinning and stopping the selected independent unisymbol reels to display a second group of credit prize symbols arranged along a second winning line that does not extend through the bonus feature symbol;
animating the letter icons “B I N G O” overlayed across the second group of credit prize symbols such that the letter icon “N” overlays a center credit prize symbol of the second group of credit prize symbols; and
animating the second group of credit prize symbols to collapse into the center credit prize symbol and modifying the center credit prize symbol to display an updated credit value equal to a sum of the credit values displayed with the second group of credit prize symbols.

13. The method of claim 8, including the one or more processors performing the algorithm including the steps of:
animating the bonus feature game grid including the second plurality of cells arranged in a 5×5 matrix defining twelve winning lines including five horizontal winning lines, five vertical winning lines, and 2 diagonal winning lines.

14. The method of claim 13, including the one or more processors performing the algorithm including the steps of:
spinning and stopping the plurality of independent unisymbol reels to display the group of credit prize symbols arranged along the winning line extending through the bonus feature symbol and to display a different group of credit prize symbols arranged along a different winning line extending through the bonus feature symbol;
animating the group of credit prize symbols to collapse into the bonus feature symbol and modifying the bonus feature symbol to display the updated credit amount; and
animating the different group of credit prize symbols to collapse into the bonus feature symbol and modifying the bonus feature symbol to display a second updated credit amount equal to a sum of the credit values displayed with the different group of credit prize symbols and the updated credit amount.

15. A non-transitory computer-readable storage media having computer-executable instructions embodied thereon to operate a gaming machine for displaying a computer-animated reel game, the gaming machine including a cabinet, a display device mounted to the cabinet and including graphical user interface (GUI) displaying computer-generated images thereon, and a control unit including one or more processors operably coupled to the display device, when executed by the one or more processors the computer-executable instructions cause the one or more processors to perform an algorithm to display an animated sequence of computer-generated images on the display device GUI including the steps of:
rendering a game screen on the display device GUI including a plurality of cells displayed in a primary game grid including a plurality of rows and a plurality of columns arranged in a 3×5 matrix, and a plurality of primary game reels displayed within the primary game grid, each primary game reel being displayed in a corresponding column;
animating the plurality of primary game reels to spin through the primary game grid and sequentially stop to display a plurality of game symbols and a plurality of feature trigger symbols within the primary game grid; and
animating a bingo-type bonus feature to appear on the GUI by:
animating each displayed feature trigger symbol to display a corresponding credit amount;
animating the primary game grid to transform into a bonus feature game grid including a second plurality of cells arranged in a 5×5 matrix;
animating a bonus feature symbol to appear in a center cell of the 5×5 matrix displaying a initial credit amount equal to a sum of the credit amounts displayed with the feature trigger symbols;
generating a plurality of independent unisymbol reels including a plurality of null symbols and at least one credit prize symbol displaying a credit value and initially displaying the plurality of independent unisymbol reels within each other cell of the bonus feature game grid displaying a null symbol; and
executing an instance of the bingo-type bonus feature by:
spinning and stopping the plurality of independent unisymbol reels to display a group of credit prize symbols arranged along a winning line extending through the bonus feature symbol;
animating the group of credit prize symbols to collapse into the bonus feature symbol; and
modifying the bonus feature symbol to display an updated credit amount equal to a sum of the credit values displayed with the group of credit prize symbols arranged along the winning line and the initial credit amount.

16. The non-transitory computer-readable storage media of claim 15, wherein the computer-executable instructions cause the one or more processors to perform the algorithm including the steps of:
replacing the group of credit prize symbols with null symbols displayed in vacated cells as the group of credit prize symbols collapses into the bonus feature symbol.

17. The non-transitory computer-readable storage media of claim 16, wherein the computer-executable instructions cause the one or more processors to perform the algorithm including the steps of:
animating the bonus feature symbol to appear as a bank vault icon; and
animating each credit prize symbol to appear as a coin icon.

18. The non-transitory computer-readable storage media of claim 17, wherein the computer-executable instructions cause the one or more processors to perform the algorithm including the steps of:
animating letter icons “B I N G O” overlayed across the group of credit prize symbols and the bonus feature symbol prior to collapsing the group of credit prize symbols into the bonus feature symbol.

19. The non-transitory computer-readable storage media of claim 18, wherein the computer-executable instructions cause the one or more processors to perform the algorithm including the steps of:
executing a subsequent instance of the bingo-type bonus feature by:
identifying independent unisymbol reels displaying null symbols;
identifying winning lines displaying only one null symbol and animating a frame icon to appear around a corresponding cell displaying the only one null symbol;
spinning and stopping the selected independent unisymbol reels to display a second group of credit prize symbols arranged along a second winning line that does not extend through the bonus feature symbol;
animating the letter icons “B I N G O” overlayed across the second group of credit prize symbols such that the letter icon “N” overlays a center credit prize symbol of the second group of credit prize symbols; and
animating the second group of credit prize symbols to collapse into the center credit prize symbol and modifying the center credit prize symbol to display an updated credit value equal to a sum of the credit values displayed with the second group of credit prize symbols.

20. The non-transitory computer-readable storage media of claim 15, wherein the computer-executable instructions cause the one or more processors to perform the algorithm including the steps of:
animating the bonus feature game grid including the second plurality of cells arranged in a 5×5 matrix defining twelve winning lines including five horizontal winning lines, five vertical winning lines, and 2 diagonal winning lines;
spinning and stopping the plurality of independent unisymbol reels to display the group of credit prize symbols arranged along the winning line extending through the bonus feature symbol and to display a different group of credit prize symbols arranged along a different winning line extending through the bonus feature symbol;
animating the group of credit prize symbols to collapse into the bonus feature symbol and modifying the bonus feature symbol to display the updated credit amount; and
animating the different group of credit prize symbols to collapse into the bonus feature symbol and modifying the bonus feature symbol to display a second updated credit amount equal to a sum of the credit values displayed with the different group of credit prize symbols and the updated credit amount.
